(19) United States
(12) Patent Application Publication
(10) Pub. No.: US 2021/0166221 A1
(43) Pub. Date: Jun. 3, 2021

(54) DEVICE AND METHOD FOR PROVIDING TRANSACTION SERVICE OF CRYPTOCURRENCY BY MEANS OF ELECTRONIC WALLET

(71) Applicant: NEXON KOREA CORPORATION, Seongnam-si, Gyeonggi-do (KR)

(72) Inventor: Ki Tae NOH, Seongdong-gu, Seoul (KR)

(21) Appl. No.: 17/048,039

(22) PCT Filed: May 8, 2018
(86) PCT No.: PCT/KR2018/005253

§ 371 Date: Oct. 15, 2020

(30) Foreign Application Priority Data
Apr. 26, 2018 (KR) 10-2018-0048475

(51) Int. Cl. G06Q 20/36; G06Q 20/06; H04L 9/06; G06Q 20/38

(52) U.S. Cl. CPC G06Q 20/3678; G06Q 20/3674; H04L 2209/38; H04L 9/0643; G06Q 20/3825; G06Q 20/0658

(57) ABSTRACT

A method of controlling operation of an electronic wallet executed in an electronic device includes executing an electronic wallet of a first user managing cryptocurrency convertible with each game cash used in at least one game application executed on the electronic device; obtaining first transaction information used to perform a transaction of cryptocurrency between the first user and a second user based on a first event generated within the at least one game application; and based on a blockchain that distributes and manages a ledger recording transactions of the cryptocurrency, performing the transaction of the cryptocurrency corresponding to the first transaction information between the electronic wallet of the first user and an electronic wallet of the second user.

### TECHNICAL FIELD

The present disclosure relates to a device and method for providing a transaction service for cryptocurrency using an electronic wallet.

### BACKGROUND ART

Online games may be played over the Internet. In order to enjoy a variety of paid online games, users pay a fee for a game with their accounts and trade items with other game users within various online games.

Accordingly, there is a need to develop an electronic wallet with integrated security management of game cash in various online games and enhanced security.

### DESCRIPTION OF EMBODIMENTS

### Technical Problem

Provided is an electronic wallet that manages cryptocurrency convertible with game cash used in a game application and performs a blockchain-based cryptocurrency transaction.

Solution To Problem

Provided is an electronic wallet that manages cryptocurrency convertible with game cash used in a game application and performs a blockchain-based cryptocurrency transaction.

### Advantageous Effects of Disclosure

By providing an electronic wallet that manages cryptocurrency convertible with game cash used in a game application, it is possible to efficiently manage game cash used in a plurality of game applications with user accounts.

By performing a blockchain-based cryptocurrency transaction, it is possible to increase the stability of the transaction.

By performing a transaction of items of a blockchain-based game application, it is possible to increase the stability of the transaction.

### BRIEF DESCRIPTION OF DRAWINGS

The present disclosure may be easily understood by the following detailed description and combinations of the accompanying drawings, and reference numerals refer to structural elements.

FIG. 1 is a conceptual diagram illustrating operation of an electronic wallet that transacts cryptocurrency convertible with game cash based on blockchain according to an embodiment.

FIG. 2 is a flowchart illustrating operation of an electronic wallet executed in an electronic device according to an embodiment.

FIG. 3 is a diagram illustrating an execution screen of an electronic wallet displayed on an electronic device according to an embodiment.

FIG. 4 is a diagram illustrating a process of converting a game cash of a game application to cryptocurrency in an electronic wallet according to an embodiment.

FIG. 5 is a diagram illustrating a process of converting cryptocurrency into a game cash of a game application in an electronic wallet according to an embodiment.

FIG. 6 is a diagram illustrating a process of transferring cryptocurrency to another user in an electronic wallet according to an embodiment.

FIG. 7 is a diagram illustrating a process of transferring cryptocurrency by supplementing insufficient cryptocurrency in a game cash of a predetermined game application when transferring the cryptocurrency to another user in an electronic wallet according to an embodiment.

FIG. 8 is a diagram illustrating a process of paying cryptocurrency to a user account of an electronic wallet when an event that satisfies a predetermined condition is performed in a predetermined game application according to an embodiment.

FIG. 9 is a diagram illustrating a transaction of cryptocurrency based on an event generated in a predetermined game application according to an embodiment.

FIG. 10 is a flowchart illustrating operation of an electronic device that performs a transaction of cryptocurrency corresponding to transaction information based on blockchain according to an embodiment.

FIG. 11 is a flowchart illustrating an operation of a node on a network of blockchain that distributes and manages a ledger that records transactions of cryptocurrency according to an embodiment.

FIG. 12 is a diagram illustrating a process of propagating a valid transaction of cryptocurrency on a network of blockchain to nodes on a network of blockchain, and recording the transaction on blockchain according to an embodiment.

FIG. 13 is a diagram illustrating a process in which an electronic device transmits digitally signed transaction information to a node on a network of blockchain according to an embodiment.

FIG. 14 is a diagram illustrating a process in which a node on a network of blockchain verifies the validity of transaction information according to an embodiment.

FIG. 15 is a block diagram illustrating a block and the structure of blockchain according to an embodiment.

FIG. 16 is a diagram illustrating a method, performed by a node on a network of blockchain, of obtaining proof of work and a nonce of a block according to an embodiment.

FIG. 17 is a diagram illustrating an effect of increasing consistency and security of transaction information by recording the transaction information on blockchain according to an embodiment.

FIG. 18 is a diagram illustrating operation of an electronic device that performs transactions of items corresponding to transaction information based on blockchain according to an embodiment.

FIG. 19 is a diagram illustrating a process in which an electronic device transacts items in a game application according to an embodiment.

FIG. 20 is a diagram illustrating a process of propagating a transaction of an item valid on a network of blockchain to nodes on a network of blockchain and recording the transaction on blockchain according to an embodiment.

FIG. 21 is a block diagram illustrating the configuration of an electronic device according to an embodiment.

FIG. 22 is a block diagram illustrating the configuration of a node on a network of blockchain according to an embodiment.

### BEST MODE

According to an aspect of the present disclosure, a method of controlling an operation of an electronic wallet executed in an electronic device includes executing an electronic wallet of a first user managing cryptocurrency convertible with each game cash used in at least one game application executed on the electronic device; obtaining first transaction information used to perform a transaction of cryptocurrency between the first user and a second user based on a first event generated within the at least one game application; and based on a blockchain that distributes and manages a ledger recording transactions of the cryptocurrency, performing the transaction of the cryptocurrency corresponding to the first transaction information between the electronic wallet of the first user and an electronic wallet of the second user.

According to another aspect of the present disclosure, an electronic device includes a communication device; a processor; a user interface device; and a memory storing instructions executable by the processor, wherein the processor is configured to, by executing the instructions, execute an electronic wallet of a first user managing cryptocurrency convertible with each game cash used in at least one game application executed on the electronic device; obtain first transaction information used to perform a transaction of cryptocurrency between the first user and a second user based on a first event generated within the at least one game application; and based on a blockchain that distributes and manages a ledger recording transactions of the cryptocurrency, perform the transaction of the cryptocurrency corresponding to the first transaction information between the electronic wallet of the first user and an electronic wallet of the second user.

According to another aspect of the present disclosure, a method of controlling an operation of an electronic wallet executed in an electronic device includes executing an electronic wallet of a first user managing cryptocurrency convertible with each game cash used in at least one game application executed on the electronic device; displaying information of the electronic wallet of the first user comprising information of cryptocurrency possessed in the electronic wallet of the first user according to an execution of the electronic wallet of the first user and information of a game cash used in each of at least one game application having an account of the first user; and performing a transaction of the cryptocurrency based on the information of the electronic wallet of the first user.

According to another aspect of the present disclosure, a method of controlling an operation of an electronic wallet executed in an electronic device includes executing an electronic wallet of a first user managing cryptocurrency convertible with each game cash used in at least one game application executed on the electronic device; based on an event generated in a first game application among the at least one game application, obtaining transfer information used to perform a transaction of the cryptocurrency between a provider providing a service of the first game application and the first user; and based on a blockchain that distributes and manages a ledger recording transactions of the cryptocurrency, performing the transaction of the cryptocurrency corresponding to the transaction information.

According to another aspect of the present disclosure, a computer-readable recording medium recording a program for executing a method of controlling an operation of an electronic wallet executed in an electronic device is provided.

According to another aspect of the present disclosure, an operation method of a first node on a network of a blockchain that distributes and manages a ledger that records transactions of cryptocurrency is provided. The operation method of the first node includes receiving, from an electronic device, first transaction information of the cryptocurrency transacted between a first user and a second user based on a first event generated in a first game application; receiving information of the first event from a server managing the first game application; verifying a validity of the first transaction information based on the first transaction information and the information of the first event; if the first transaction information is valid, transmitting the first transaction information to a second node on the network of the blockchain, and adding the first transaction information to a candidate block; and performing a proof of work on the candidate block, and adding the candidate block to the blockchain as a valid block.

According to another aspect of the present disclosure, a first node on a network of a blockchain that distributes and manages a ledger that records transactions of cryptocurrency is provided. The first node includes a communication device; a processor; and a memory storing instructions executable by the processor, wherein the processor is configured to, by executing the instructions, receive, from an electronic device, first transaction information of the cryptocurrency transacted between a first user and a second user based on a first event generated in a first game application; receive information of the first event from a server managing the first game application; verify a validity of the first transaction information based on the first transaction information and the information of the first event; if the first transaction information is valid, transmit the first transaction information to a second node on the network of the blockchain, and add the first transaction information to a candidate block; and perform a proof of work on the candidate block, and adding the candidate block to the blockchain as a valid block.

According to another aspect of the present disclosure, a computer-readable recording medium recording a program for executing an operation method of a first node on a network of a blockchain that distributes and manages a ledger that records transactions of cryptocurrency is provided.

### Mode of Disclosure

Hereinafter, various embodiments will be described in detail with reference to the accompanying drawings. The embodiments described hereinafter may be embodied in many different forms. To more clearly describe the features of the embodiments, a detailed description of known matters to those skilled in the art to which the embodiments belong will be omitted.

Meanwhile, in the specification, when it is described that an element is “connected” to another element, the element may be “directly connected” to the other element or “connected” to the other element through a third element. In addition, unless explicitly described to the contrary, the word “comprise” and variations such as “comprises” or “comprising”, will be understood to imply the inclusion of stated elements but not the exclusion of any other elements.

As used herein, terms including ordinals such as ‘first’ or ‘second’ may be used to describe various elements, but the elements should not be limited by the terms. The terms are only used for the purpose of distinguishing one element from another.

In the present specification, an “electronic wallet” may refer to means storing values in an electronic way on an electronic device and enabling transactions online or offline without exchanging real money. In addition, the “electronic wallet” is a kind of an electronic payment system used in electronic commerce and may refer to software that stores the money value in a memory of the electronic device or a virtual account and uses as a wallet while settling payment upon the electronic commerce.

In the present specification, an “event” may refer to an event generated within a game application that is the basis for generating a transaction of cryptocurrency between a user and another user or a transaction of cryptocurrency between the user and a provider providing a service of the game application.

In the presnet specification, “cryptocurrency” may mean a digital currency designed to be used as an exchange means using an encryption method. In addition, the “cryptocurrency” may use the encryption method to ensure the security of transactions, control the creation of additional units, and authenticate the transfer of assets.

In the present specification, “game cash” may mean a digital currency designed to be used as an exchange means in a game.

In the present specification, “blockchain” may refer to a distributed Peer to Peer (P2P) system of a ledger that utilizes a software element composed of algorithms in which blocks connected in order negotiate transaction information using encryption and security techniques so as to secure and maintain integrity. Here, the distributed P2P system may be a special form of a distributed system. In addition, in the P2P system, all nodes of the network may provide resources (processing power, storage space, data or network bandwidth, etc.) to each other without coordination of a central node. In addition, a “blockchain” may mean a distributed ledger technology that nodes in a network jointly record and manage by distributing the ledger recording transaction information to a P2P network rather than a central server of a specific institution.

In the present specification, an “electronic device” may mean a device that operates by receiving electrical energy. For example, the electronic device may be a smart phone, a tablet PC, a PC, a TV, a smart TV, a mobile phone, a personal digital assistant (PDA), a laptop, or a non-mobile computing device, but is not limited thereto.

In the present specification, a “node” may mean a component within a network of blockchain. For example, the node may be a special-purpose computer, a general-purpose computer, a supercomputer, a mainframe computer, a personal computer, a smartphone, and a tablet PC, etc., but is not limited thereto.

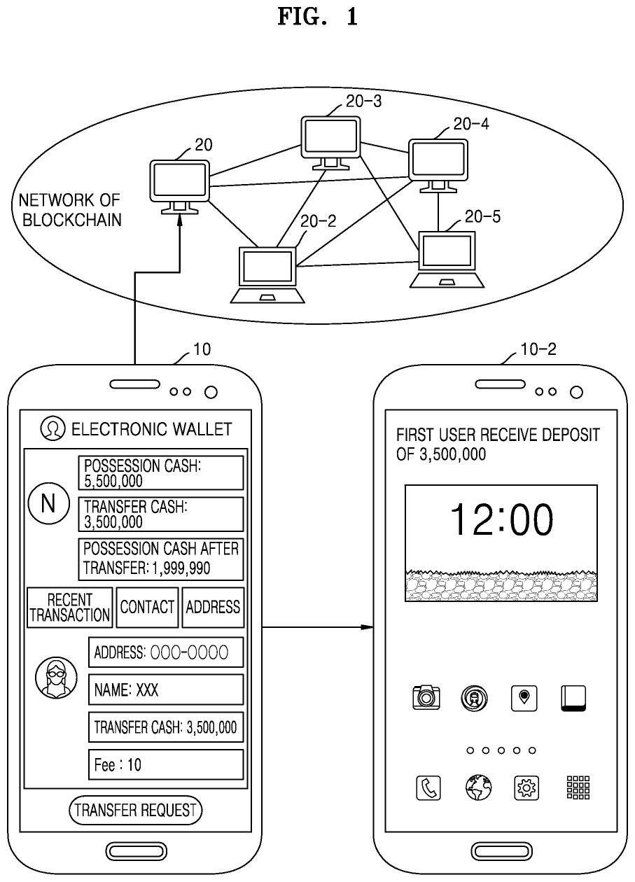

FIG. 1 is a conceptual diagram illustrating an operation of an electronic wallet that transacts cryptocurrency convertible with game cash based on blockchain according to an embodiment.

An electronic device 10 may execute the electronic wallet of a first user managing cryptocurrency according to an input of the first user. The electronic device 10 may perform a transaction of cryptocurrency based on first transaction information used by the first user to transfer a predetermined cryptocurrency to a second user.

The electronic device 10 may transmit the first transaction information to a first node 20 among nodes 20, 20-2, 20-3, 20-4, and 20-5 on a network of blockchain so as to record details of the first user transferring the predetermined cryptocurrency to the second user. An electronic device 10-2 owned by the second user may receive a message in which the predetermined cryptocurrency is deposited from the first user.

Meanwhile, the first node 20 may verify the validity of the first transaction information and add the first transaction information to a candidate block when the first transaction information is valid. The first node 20 may perform a proof of work on the candidate block to add the candidate block to blockchain as a valid block.

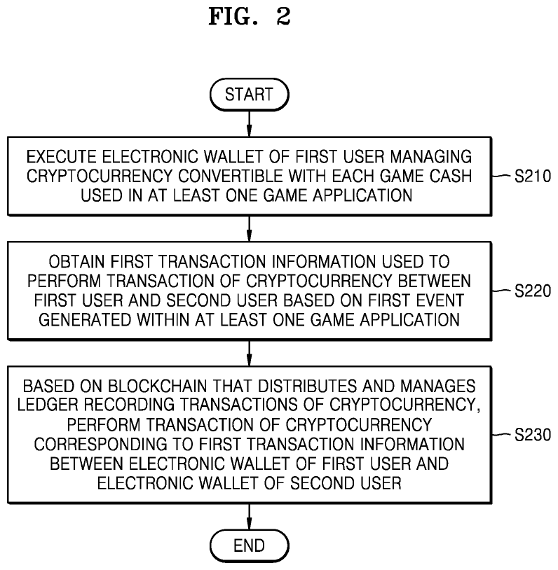

FIG. 2 is a flowchart illustrating an operation of an electronic wallet executed in an electronic device according to an embodiment.

In operation S210, the electronic device 10 may execute the electronic wallet of a first user managing cryptocurrency. Cryptocurrency may be interconvertable with each game cash used in at least one game application executed in the electronic device 10.

In operation S220, the electronic device 10 may obtain first transaction information used to perform a transaction of cryptocurrency between the first user and a second user. The transaction of cryptocurrency between the first user and the second user may be determined based on a first event generated in a first game application among the at least one game application. Here, the first event may be generated by a predetermined action between the first user and the second user while the first game application is being executed. Further, the first event may be an event generated in the first game application that is the basis for generating the transaction of cryptocurrency between the first user and the second user.

For example, the first event may be a result of a betting game between the first user and the second user in the first game application. In the betting game, betting may mean that a user who lost the game pays predetermined cryptocurrency to a user who won the game as a reward. The electronic device 10 may obtain the first transaction information corresponding to the transaction of cryptocurrency determined based on the result of the betting game between the first user and the second user.

For another example, the first event may be a conversation made between the first user and the second user in the first game application. The electronic device 10 may obtain the first transaction information corresponding to the transaction of cryptocurrency determined based on content of the conversation made between the first user and the second user.

The first transaction information may include at least one of address information of an electronic wallet of the first user, address information of an electronic wallet of the second user, information of a user who is to transfer cryptocurrency, information of the transfer amount of cryptocurrency to be transferred, time information of cryptocurrency to be transferred, information about a fee according to a transfer of cryptocurrency, and information proving whether the user who is to transfer cryptocurrency agrees to the transfer of cryptocurrency.

The electronic device 10 may obtain the first transaction information based on at least one of user input information received from a user interface device of the electronic device 10, transfer history information transacted in the electronic wallet, and information of the first event obtained from a server managing the first game application.

In operation S230, the electronic device 10 may perform the transaction of cryptocurrency corresponding to the first transaction information between the electronic wallet of the first user and the electronic wallet of the second user, based on blockchain that distributes and manages a ledger recording the transaction of cryptocurrency.

The electronic device 10 may perform the transaction of cryptocurrency between the electronic wallet of the first user and the electronic wallet of the second user according to the first transaction information.

The electronic device 10 may request the first node 20 on the network of blockchain to record the first transaction information on a block constituting blockchain in order to verify the transaction of cryptocurrency. The electronic device 10 may encrypt the first transaction information and transmit the encrypted first transaction information to the first node 20. Specifically, the electronic device 10 may apply the first transaction information to a hash function to generate a first hash value corresponding to the first transaction information. Here, the hash function may generate unique data of the first transaction information. The electronic device 10 may encrypt the first hash value with a private key of the first user to generate a first cryptogram indicating a digital signature of the first transaction information. The electronic device 10 may transmit the first cryptogram along with the first transaction information to the first node 20.

The electronic device 10 may complete the transaction of cryptocurrency corresponding to the first transaction information by receiving a message indicating that the transaction of cryptocurrency has been verified from the network of blockchain.

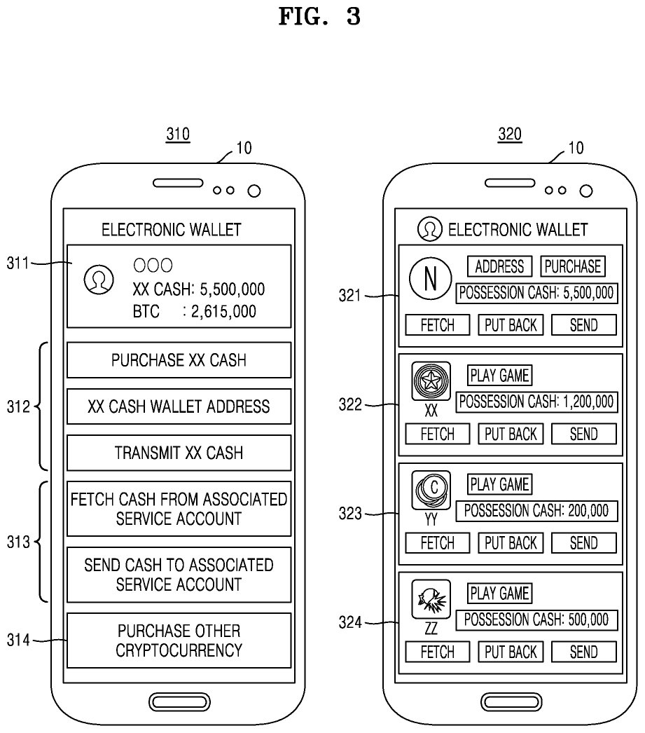

FIG. 3 is a diagram illustrating an execution screen of an electronic wallet displayed on an electronic device according to an embodiment.

Referring to 310 of FIG. 3, the electronic device 10 may display a user interface managing account information of a first user with respect to cryptocurrency and the cryptocurrency according to the execution of the electronic wallet of the first user.

Specifically, the electronic device 10 may display account information 311 of the first user including information such as a name of the first user, a balance of a cryptocurrency XX cash, and balance of other cryptocurrencies. The electronic device 10 may display icons 312 capable of purchasing the cryptocurrency XX cash, providing an electronic wallet address of the cryptocurrency XX cash, and transmitting the cryptocurrency XX cash. The electronic device 10 may display icons 313 capable of fetching the cash from an account of the first user of a service associated with the electronic wallet of the first user and sending the cash to the account of the first user of the service associated with the electronic wallet of the first user. Here, the service associated with the electronic wallet may be a service provided by at least one game application executed on the electronic device 10. The electronic device 10 may display the icons 313 related to the service associated with the electronic wallet of the first user such that the first user may access the account of the first user of the service associated with the electronic wallet of the first user in the electronic wallet of the first user without separately executing the service associated with the electronic wallet. In addition, the electronic device 10 may also display an icon 314 capable of selling cryptocurrencies other than the cryptocurrency XX. When receiving an input for selecting the icon 314, the electronic device 10 may display the execution screen of the electronic wallet such that transactions between cryptocurrencies other than the cryptocurrency XX may be performed.

Also, referring to 320 of FIG. 3, the electronic device 10 may display an execution screen of the electronic wallet according to the execution of the electronic wallet of the first user. The electronic device 10 may display information of cryptocurrency possessed in the electronic wallet of the first user, and the user interface for managing cryptocurrency. Further, the electronic device 10 may display information of a game cash used in each of at least one game application having the account of the first user, and a user interface related to the game cash. The electronic device 10 may display the information of the game cash used in each of at least one game application having the account of the first user, and the user interface related to the game cash, such that the first user may conveniently convert between the game cash used in each of at least one game application and cryptocurrency. In addition, the electronic device 10 may provide the electronic wallet that manages cryptocurrency convertible with the game cash used in the game application such that the first user may efficiently manage game cashes used in a plurality of game applications having the account of the first user.

Specifically, referring to 321 of FIG. 3, the electronic device 10 may display the balance information of cryptocurrency owned in the account of the first user. The electronic device 10 may display icons capable of providing the electronic wallet address of cryptocurrency, purchasing the cryptocurrency, fetching game cash from the game cash associated with the cryptocurrency, putting the cryptocurrency back to the game cash associated with the cryptocurrency, and sending the cryptocurrency to an electronic wallet of another user.

Further, referring to 322, 323, and 324 of FIG. 3, the electronic device 10 may display the balance information of the game cash used in each of the game applications having the account of the first user. In addition, the electronic device 10 may display icons capable of fetching game cash from cryptocurrency, putting the game cash back to the cryptocurrency, and sending the game cash to another user, with respect to each of the game applications having the account of the first user.

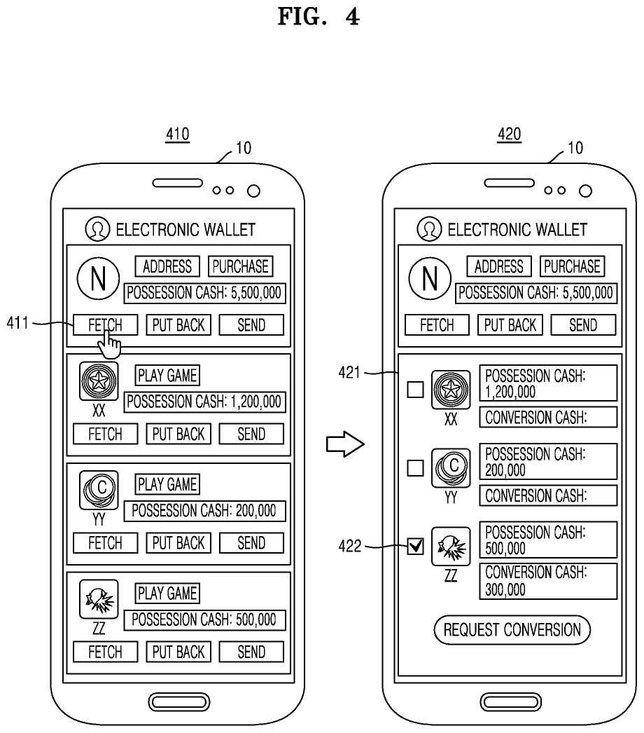

FIG. 4 is a diagram illustrating a process of converting a game cash of a game application to cryptocurrency in an electronic wallet according to an embodiment.

The electronic device 10 may receive an input of a first user that controls to interconvert between a first game cash in a first game application having an account of the first user and cryptocurrency. The electronic device 10 may interconvert between cryptocurrency and the first game cash based on the input of the first user and an exchange rate between cryptocurrency and the first game cash.

Referring to 410 of FIG. 4, the electronic device 10 may receive an input for selecting an icon 411 capable of fetching a game cash from a game cash associated with cryptocurrency.

Referring to 420 of FIG. 4, the electronic device 10 may display information 421 of possession cash with respect to each of a plurality of game applications having the account of the first user. The electronic device 10 may receive an input 422 for selecting a ZZ game application from among the plurality of game applications, and may receive an input for converting 300,000 cashes among possession cashes of a ZZ game into cryptocurrency. For example, when the exchange rate between cryptocurrency and the game cash of the ZZ game is 1, the balance of cryptocurrency in the electronic device 10 may further increase by 300,000 cashes.

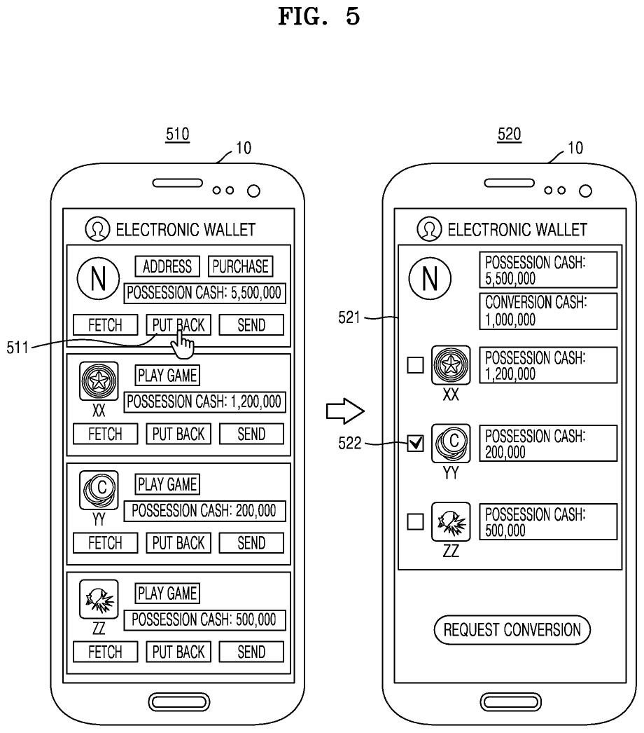

FIG. 5 is a diagram illustrating a process of converting cryptocurrency into a game cash of a game application in an electronic wallet according to an embodiment.

Referring to 510 of FIG. 5, the electronic device 10 may receive an input for selecting an icon 511 capable of putting cryptocurrency back to the game cash associated with the cryptocurrency.

Referring to 520 of FIG. 5, the electronic device 10 may display information 521 of possession cash with respect to each of a plurality of game applications having an account of a first user. The electronic device 10 may receive an input 522 for selecting a YY game application among the plurality of game applications, and may receive an input for converting 1,000,000 cashes of cryptocurrency into a game cash of a YY game. The electronic device 10 may increase the balance of the game cash of the YY game based on an exchange rate between the cryptocurrency and the game cash of the YY game.

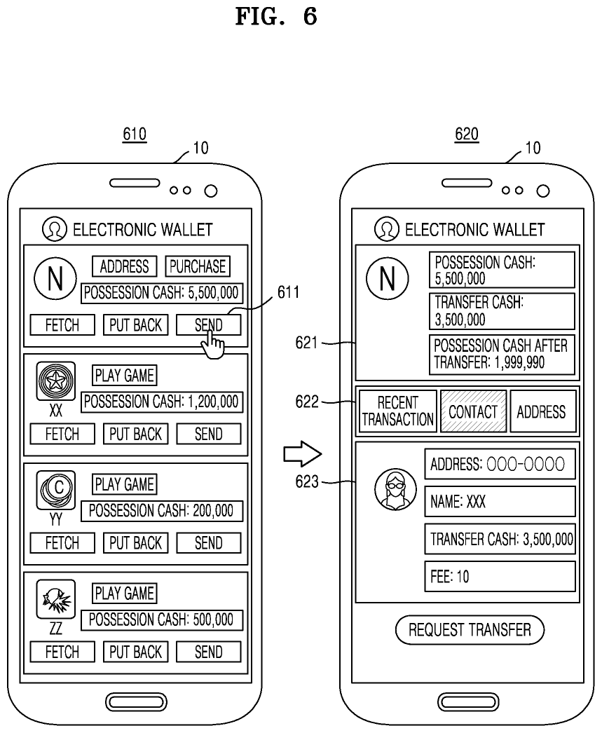

FIG. 6 is a diagram illustrating a process of transferring cryptocurrency to another user in an electronic wallet according to an embodiment.

Referring to 610 of FIG. 6, the electronic device 10 may receive an input for selecting an icon capable of sending cryptocurrency to an electronic wallet of another user.

Referring to 620 of FIG. 6, the electronic device 10 may display information used to transfer cryptocurrency from an electronic wallet of a first user to an electronic wallet of a second user, and balance information 621 of the cryptocurrency to be changed by transferring the cryptocurrency.

The electronic device 10 may display icons 622 that provide history information of the recent transaction of cryptocurrency, contact information stored in the electronic device 10, and information of the electronic wallet stored in the electronic device 10.

The electronic device 10 may receive at least one of address information of the electronic wallet of the second user, information of the second user, information of a transfer amount that the first user transfers to the second user, and information of fee according to the transfer of the cryptocurrency to obtain first transaction information 623 used to perform the transaction of the cryptocurrency between the first user and the second user.

Meanwhile, the fee according to the transfer of the cryptocurrency may be generated whenever the first user transfers the cryptocurrency to another user. In addition, the fee may be determined based on the number of transfers of cryptocurrency of the first user, the transfer amount, and a transfer time. For example, if the number of transfers of cryptocurrency of the first user is more than a predetermined number of times per month, a fee of 20% discount may apply. For another example, an amount corresponding to a period to which the transfer amount of cryptocurrency belongs among preset periods may be applied to a fee. In this case, the more the transfer amount of the cryptocurrency, the higher the amount of the fee. As another example, if the first user applies for a reservation transfer for the transaction of cryptocurrency in advance, a predetermined discount rate may be applied to the fee. In addition, a fee for transactions between the same kind of cryptocurrencies may be lower than a fee for transactions between different kinds of cryptocurrencies. Also, the fee may be paid as a game cash in a game application having an account of the first user.

The fee incurred in the transaction of cryptocurrency may be distributed as rewards to nodes on the network of blockchain that distributes and manages a ledger recording the transaction of cryptocurrency. By paying fees as rewards to the nodes on the network of blockchain, it is possible to achieve the integrity of blockchain and increase the work efficiency of the nodes.

In addition, in the case of blockchain that utilizes a distributed system but utilizes a centralized control system with partial access restrictions, the fee incurred in the transaction of cryptocurrency may be paid to a server that controls blockchain.

The electronic device 10 may receive an input for selecting an icon for requesting transfer, and transfer a predetermined cryptocurrency from the electronic wallet of the first user to the electronic wallet of the second user.

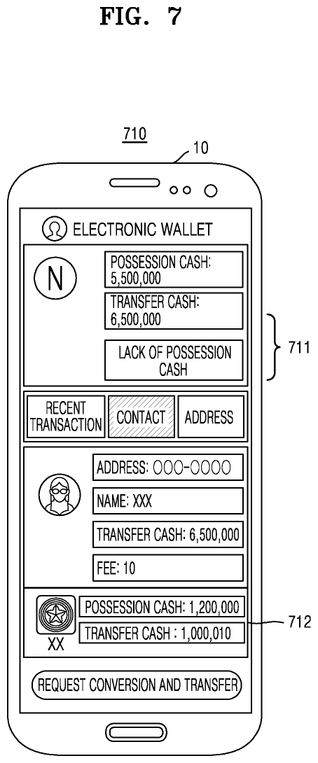

FIG. 7 is a diagram illustrating a process of transferring cryptocurrency by supplementing insufficient cryptocurrency in a game cash of a predetermined game application when transferring the cryptocurrency to another user in an electronic wallet according to an embodiment.

When a first user transfers a predetermined amount of cryptocurrency possessed in the electronic wallet to a second user, the predetermined amount of cryptocurrency to be transferred may be greater than the possession amount of cryptocurrency possessed in the electronic wallet of the first user. The electronic device 10 may convert a first game cash of a first game application into the cryptocurrency by a difference between the predetermined amount of cryptocurrency and the possession amount of cryptocurrency. In this case, the first user may convert the cryptocurrency into the first game cash of the first game application possessed by the first user without having to charge the cryptocurrency.

Referring to 710 of FIG. 7, the cryptocurrency that the first user intends to transfer to the second user is 6,500,000 cash, but the cryptocurrency possessed by the first user is 5,500,000 cash. The electronic device 10 may convert XX game cash 1,000,010 of an XX game application into cryptocurrency by a difference (1,000,000 cash) between cryptocurrency 6,500,000 cash to be transferred to the second user and cryptocurrency 5,500,000 cash possessed by the first user and a fee (10 cash)

The electronic device 10 may receive information of the game cash of the predetermined game application from a server of the predetermined game application and display the information on an execution screen of the electronic wallet. The electronic device 10 may supplement the insufficient cryptocurrency when transferring the cryptocurrency in the game cash of the predetermined game application based on the information of the game cash of the predetermined game application.

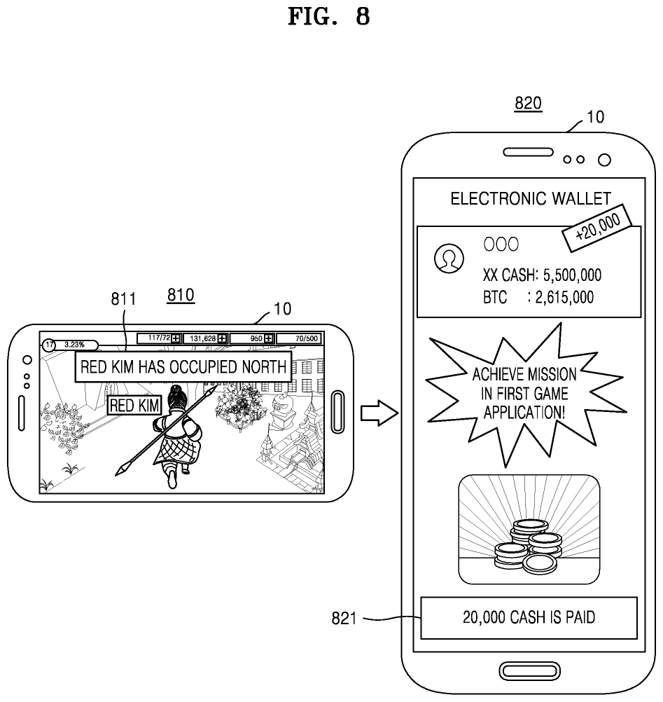

FIG. 8 is a diagram illustrating a process of paying cryptocurrency to a user account of an electronic wallet when an event that satisfies a predetermined condition is performed in a predetermined game application according to an embodiment.

The electronic device 10 may perform a transaction of cryptocurrency between a provider providing a service of a first game application and a first user based on the event generated in the first game application.

For example, the electronic device 10 may receive a message indicating that a predetermined event has been performed in the first game application from a server of the provider providing the service of the first game application. Also, the electronic device 10 may obtain information indicating that the predetermined event is achieved at the same time as the predetermined event is achieved in the first game application. The electronic device 10 may receive the cryptocurrency from the server of the provider in an electronic wallet of the first user.

Here, the event may be an event that may generate the transaction of cryptocurrency between the first user and the provider. For example, the event may be an event in which an action that satisfies a condition proposed by the provider is performed in the first game application. For a specific example, the event may be occupying a predetermined region with a first character owned by the first user in the first game application. For another example, the event may be repeating a predetermined action with the first character owned by the first user in the first game application.

When the event that satisfies the predetermined condition is performed in the first game application having an account of the first user, the electronic device 10 may receive cryptocurrency from a server of the first game application.

Referring to 810 of FIG. 8, the provider that provides the service of the first game application may set in advance a condition that a predetermined cryptocurrency is paid whenever a user occupies a predetermined region in the first game application. Here, an amount of cryptocurrency paid for each occupied region may be different. For example, the provider may set the condition that XX cryptocurrency 20,000 cash is paid when the user achieves an event 811 of occupying the north in the first game application. In the first game application, the first user may achieve the event 811 of “occupying the north”.

Referring to 820 of FIG. 8, when the first user achieves the event 811 of “occupying the north” in the first game application, the electronic device 10 may receive a message indicating that “a northern occupation mission has been achieved in the first game application” from the server of the provider. The electronic device 10 may receive the XX cryptocurrency 20,000 cash according to a preset reward criterion from the server of the provider providing the service of the first game application. The electronic device 10 may display a message 821 indicating that the XX cryptocurrency has been paid.

The provider providing the service of the first game application may promote activation of the first game application by paying the predetermined cryptocurrency when a predetermined user achieves the predetermined event in the first game application.

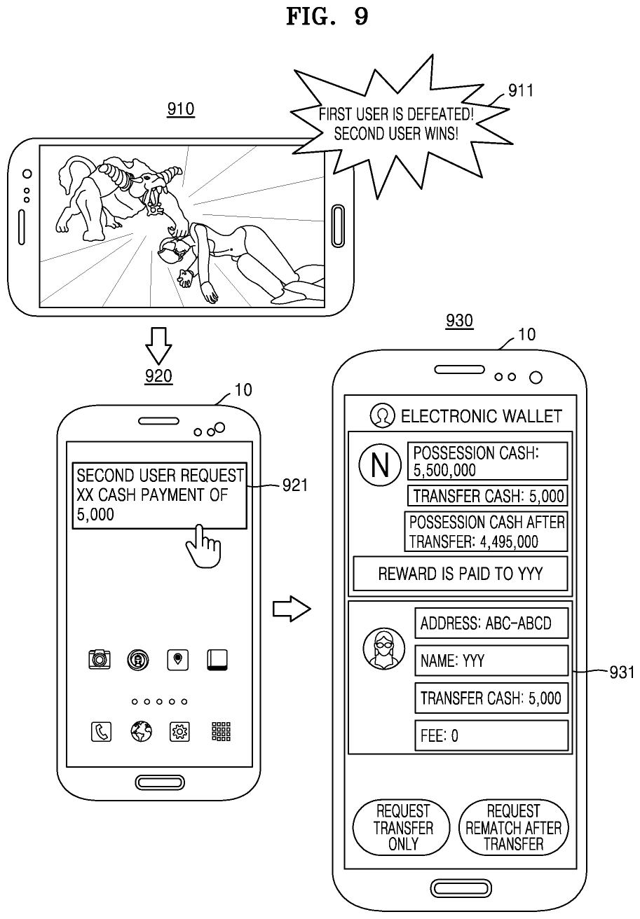

FIG. 9 is a diagram illustrating a transaction of cryptocurrency based on an event generated in a predetermined game application according to an embodiment.

The electronic device 10 may perform the transaction of cryptocurrency between a first user and a second user based on the event generated in the first game application. Here, the event may be an event in the first game application that is the basis for generating the transaction of cryptocurrency between the first user and the second user. For example, an event may be generated in which the first user compensates the second user for cryptocurrency according to an operation between the first user and the second user performed in the first game application. Referring to 910 of FIG. 9, the first user and the second user may agree to pay a predetermined cryptocurrency as a reward by a user who lost to a user who won in a betting game within the first game application. As a result of the betting game, an event 911 in which the first user is defeated and the second user wins may be generated.

Because an event in which the first user must compensate the second user for the cryptocurrency is generated according to the operation between the first user and the second user, the electronic device 10 may receive a message requesting transfer of a predetermined amount of preset cryptocurrency to an electronic wallet of the second user from a server of the first game application. Referring to 920 of FIG. 9, the electronic device 10 may receive a message that “the second user requests a 5,000 cash payment” from the server of the first game application.

When the electronic device 10 receives an input for authorizing the transfer of the predetermined amount of cryptocurrency, the electronic device 10 may transfer the predetermined amount of cryptocurrency from an electronic wallet of the first user to the electronic wallet of the second user based on blockchain. As illustrated in 920 of FIG. 9, when the electronic device 10 receives an input 921 for selecting the message that “the second user requests a 5,000 cash payment”, the electronic device 10 may execute the electronic wallet. Referring to 930 of FIG. 9, the electronic device 10 may display transaction information 931 used to transfer cryptocurrency 5,000 cash to the second user. Also, the electronic device 10 may display an icon for “applying for transfer only” and an icon for “requesting for rematch after transfer”. The electronic device 10 may perform an operation corresponding to the selected icon.

Meanwhile, when the predetermined event agreed between the first user and the second user is achieved within the first game application, the transaction of cryptocurrency between the first user and the second user is performed, thereby promoting activation of the first game application.

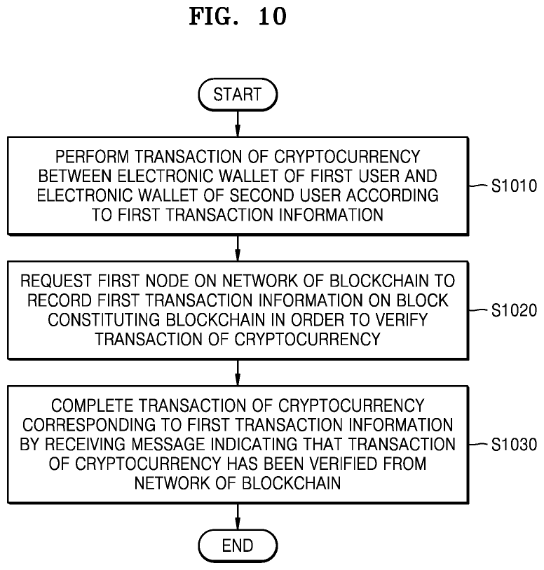

FIG. 10 is a flowchart illustrating an operation of an electronic device that performs a transaction of cryptocurrency corresponding to transaction information based on blockchain according to an embodiment.

In operation S1010, the electronic device 10 may perform the transaction of cryptocurrency between an electronic wallet of a first user and an electronic wallet of a second user according to first transaction information.

In operation S1020, the electronic device 10 may request the first node 20 on the network of blockchain to record the first transaction information on a block constituting blockchain in order to verify the transaction of cryptocurrency. The electronic device 10 may encrypt the first transaction information and transmit the encrypted first transaction information to the first node 20. Specifically, the electronic device 10 may apply the first transaction information to a hash function to generate a first hash value corresponding to the first transaction information. Here, the hash function may generate unique data of the first transaction information. The electronic device 10 may encrypt the first hash value with a private key of the first user to generate a first cryptogram indicating a digital signature of the first transaction information. The electronic device 10 may transmit the first cryptogram along with the first transaction information to the first node 20.

In operation S1030, the electronic device 10 may complete the transaction of the cryptocurrency corresponding to the first transaction information by receiving a message indicating that the transaction of the cryptocurrency has been verified from the network of blockchain.

The electronic device 10 may ensure the security of the transaction of the cryptocurrency by performing the transaction of the cryptocurrency between the first user and the second user based on blockchain.

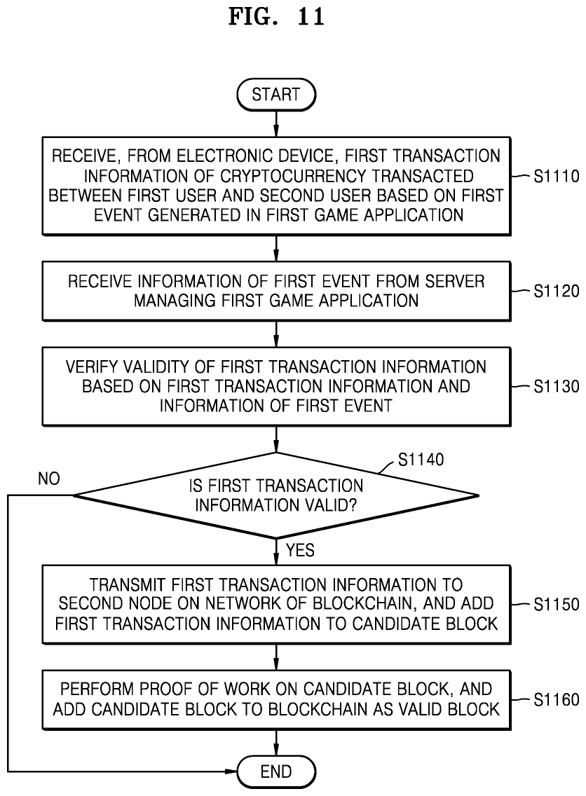

FIG. 11 is a flowchart illustrating an operation of a node on a network of blockchain that distributes and manages a ledger that records transactions of cryptocurrency according to an embodiment.

In operation S1110, the first node 20 on the network of blockchain that distributes and manages the ledger recording the transactions for the cryptocurrency may receive first transaction information from the electronic device 10 of a first user. Here, the first transaction information may be transaction information of cryptocurrency transacted between the first user and a second user determined based on a first event generated in a first game application.

In operation S1120, the first node 20 may receive information of the first event from a server managing the first game application.

In operation S1130, the first node 20 may verify the validity of the first transaction information based on the first transaction information and the information of the first event.

In operation S1140, if the first transaction information is valid, the first node 20 may perform an operation according to operation S1150. Meanwhile, if the first transaction information is not valid, the first node 20 may discard the first transaction information.

In operation S1150, the first node 20 may transmit the first transaction information to a second node on the network of blockchain. Further, the first node 20 may add the first transaction information to a candidate block of a block that may be connected to blockchain.

In operation S1160, the first node 20 may perform a proof of work on the candidate block, and add the candidate block to blockchain as a valid block.

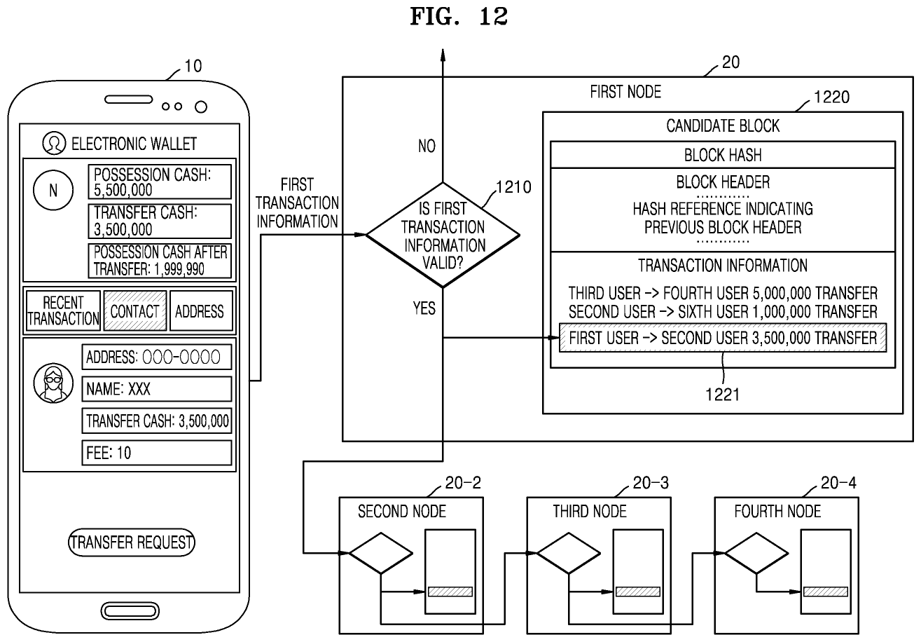

FIG. 12 is a diagram illustrating a process of propagating a valid transaction of cryptocurrency on the network of blockchain to nodes on the network of blockchain, and recording the transaction on blockchain according to an embodiment.

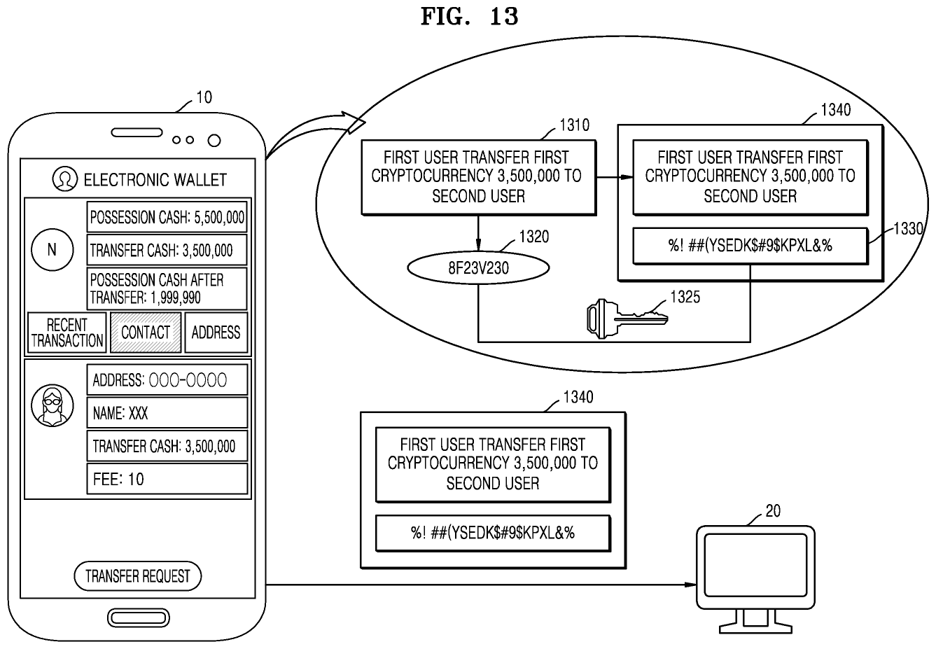

Referring to FIG. 12, the electronic device 10 may execute an electronic wallet of a first user. The electronic device 10 may transfer cryptocurrency 3,500,000 cash to an electronic wallet of a second user, based on first transaction information indicating information indicating that the first user has transferred the cryptocurrency 3,500,000 cash to the second user. The electronic device 10 may encrypt the first transaction information and transmit the encrypted first transaction information to the first node 20 on the network of blockchain. The operation performed by the electronic device 10 of encrypting the first transaction information and transmitting the encrypted first transaction information to the first node 20 will be described in detail with reference to FIG. 13.

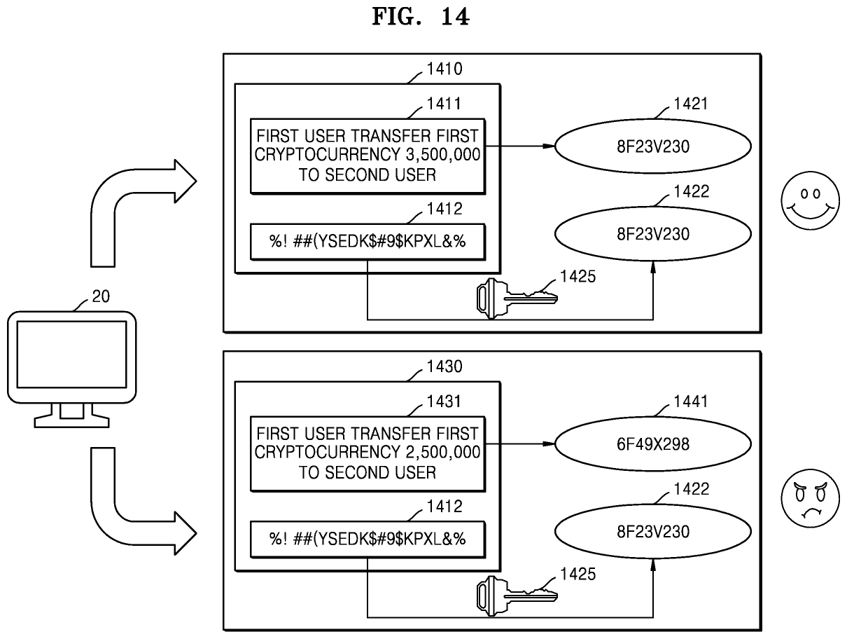

The first node 20 may decrypt the encrypted first transaction information and verify 1210 whether the first transaction information is valid based on a decryption result. The operation performed by the first node 20 of verifying the validity of the first transaction information will be described in detail in FIG. 14.

As a result of verifying the validity of the first transaction information, if the first transaction information is not valid, the first node 20 may discard the first transaction information.

As a result of verifying the validity of the first transaction information, if the first transaction information is valid, the first node 20 may transmit the first transaction information to a second node 20-2 on the network of blockchain. In addition, the first node 20 may record first transaction information 1221 indicating information that the first user has transferred cryptocurrency 3,500,000 cash to the second user on a candidate block 1220. When predetermined transaction information is recorded on the candidate block 1220, the first node 20 may perform proof of work on the candidate block 1220 to generate a valid block. In addition, when the validity of the first transaction information 1221 is also verified in the second node 20-2, the second node 20-2 may add the first transaction information 1221 to the candidate block 1220 and perform proof of work on the candidate block 1220 to generate the valid block. A third node 20-3 and a fourth node 20-4 may operate in the same way as the second node 20-2.

Referring to the process that the first node 20 generates the valid block and add the valid block to blockchain, the first node 20 may calculate t root of a Merkle tree with respect to predetermined transaction information. The first node 20 may generate a hash reference indicating a previous block header from a block to be added to blockchain. The first node 20 may obtain the difficulty required in a proof of work or a constraint of the block to be added to blockchain. The first node 20 may confirm whether a value of a block hash that is generated by applying a hash function to the root of the Merkle tree, the hash reference indicating the previous block header, the difficulty, data of timestamp, and a nonce satisfies the constraint. The first node 20 may increase the nonce from 0 by 1 and obtain a value of the nonce that satisfies the constraint, thereby performing the proof of work on the candidate block 1220. The first node 20 may add the candidate block 1220 to blockchain as the valid block. In addition, the first node 20 may transmit the valid block to the other nodes 20-2, 20-3, 20-4, etc. on the network of blockchain.

Each of the nodes 20-2, 20-3, 20-4, etc. on the network of blockchain may perform verification on the valid block received from the first node 20 to add the valid block to blockchain possessed by each of the nodes 20-2, 20-3, 20-4, etc.

FIG. 13 is a diagram illustrating a process in which an electronic device transmits digitally signed transaction information to a node on the network of blockchain according to an embodiment.

The electronic device 10 may encrypt transaction information 1310 that “a first user transfers first cryptocurrency 3,500,000 cash to a second user”, and transmit encrypted transaction information 1340 to the first node 20 on the network of blockchain.

Specifically, the electronic device 10 may apply the transaction information 1310 that “the first user transfers first cryptocurrency 3,500,000 cash to the second user” to a hash function for generating unique data of the transaction information 1310 to generate a hash value 1320 “8F23V230” corresponding to the transaction information 1310.

The electronic device 10 may encrypt the hash value 1320 “8F23V230” with a private key 1325 of the first user to generate a first cryptogram 1330 “%! ##(YSEDK$#9$KPXL& %” indicating a digital signature of the transaction information 1310. The electronic device 10 may transmit the transaction information 1340 combining the first cryptogram 1330 “%! ##(YSEDK$#9$KPXL& %” with the transaction information 1310 to the first node 20.

FIG. 14 is a diagram illustrating a process in which a node on a network of blockchain verifies the validity of transaction information according to an embodiment.

For example, the first node 20 may receive transaction information 1410 from the electronic device 10 of a first user. The transaction information 1410 may include transaction information 1411 that “the first user transfers first cryptocurrency 3,500,000 cash to a second user” and a first cryptogram 1412 “%! ##(YSEDK$#9$KPXL& %”. The first node 20 may apply a hash function to the transaction information 1411 to generate a hash value 1421 “8F23V230” corresponding to the transaction information 1411. The first node 20 may decrypt the first cryptogram 1412 “%! ##(YSEDK$#9$KPXL& %” using a public key 1425 of the first user to generate a hash value 1422 “8F23V230”. Because the hash value 1421 “8F23V230” and the hash value 1422 “8F23V230” are the same, the first node 20 may determine that the transaction information 1410 received from the electronic device 10 of the first user is valid.

For another example, the first node 20 may receive transaction information 1430 from the electronic device 10 of the first user. The transaction information 1430 may include the transaction information 1431 that “the first user transfers first cryptocurrency 2,500,000 cash to the second user” and the first cryptogram 1412 “%!##(YSEDK$#9$KPXL& %”. The first node 20 may apply a hash function to the transaction information 1431 to generate a hash value 1441 “6F49X298” corresponding to the transaction information 1431. The first node 20 may decrypt the first cryptogram 1412 “%! ##(YSEDK$#9$KPXL& %” using the public key 1425 of the first user to generate the hash value 1422 “8F23V230”. Because the hash value 1441 “6F49X298” and the hash value 1422 “8F23V230” are not the same, the first node 20 may determine that the transaction information 1430 received from the electronic device 10 of the first user is invalid

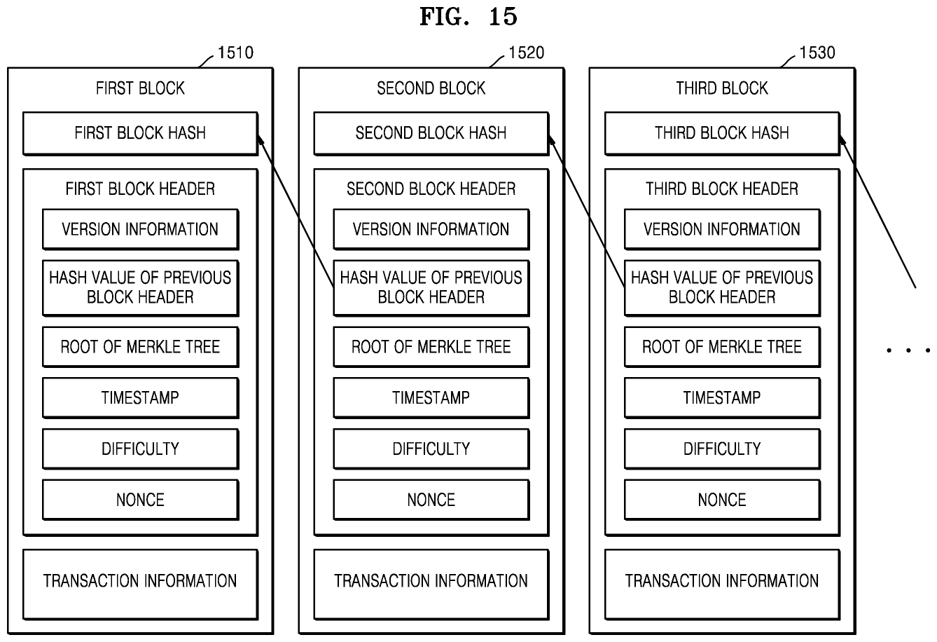

FIG. 15 is a block diagram illustrating a block and the structure of blockchain according to an embodiment.

As shown in FIG. 15, blockchain may be configured by connecting blocks recording valid transaction information. That is, the data structure of blockchain may be a predetermined data structure including units in which blocks recording transaction information are arranged in order. In addition, the data structure of blockchain may be configured as a data structure in which respective block headers are connected in the format of a chain with reference to previous block headers, and a data structure of a Merkle tree in which hash references indicating data of transaction information and the data of the transaction information are connected in the shape of a tree.

The block may include a block hash, block header, transaction information, and the like. The block header may include a version of the current program, a hash value of a previous block header, a root of a Merkle tree, a timestamp, difficulty and information of a nonce.

The block hash may be a hash value of a hash function applied using the version of the current program, the hash value of the previous block header, the root of the Merkle tree, the timestamp, the difficulty and the information of the nonce as input values. That is, the value of the block hash may be a value obtained by hashing the block header, not a value obtained by hashing the entire block.

The hash value of the previous block header may be used to uniquely identify each block header and refer to the previous block header. If each block header refers to the previous block header, the order of individual block headers and blocks may be maintained. Referring to FIG. 15, because a first block 1510 is a first block and has no previous block, there is no reference indicating the previous block header. Therefore, the hash value of the previous block header of the first block 1510 is 0. Also, because a second block 1520 has the first block 1510 as a previous block, a second block header has a hash value indicating a first block header. Similarly, because a third block 1530 has the second block 1520 as a previous block, a third block header has a hash value indicating the second block header.

The Merkle tree may refer to a structure in which the hash references and the data of the transaction information are connected in the form of the tree. The hash references may refer to the data of the transaction information using an encrypted hash value. Meanwhile, because the encrypted hash value is a unique value of data, different data do not have the same hash value.

Upon explaining a process of generating the Merkle tree in detail, the hash references (e.g., a first hash reference, a second hash reference, a third hash reference, and a fourth hash reference) respectively indicating the data of the transaction information (e.g., first transaction information, second transaction information, third transaction information, and fourth transaction information) may be generated. When the hash references are generated, hash references (e.g., a 12th hash reference indicating the first hash reference and the second hash reference and a 34th hash reference indicating the third hash reference and the fourth hash reference) indicating pairs of the hash references may be generated. Then, a work of generating the hash references indicating the pairs of hash references may be repeatedly performed to generate a single hash reference (e.g., a 1234th hash reference indicating the 12th hash reference and the 34th hash reference). That is, the Merkle tree may be a tree-shape structure that starts from the single hash reference and is connected to the data of each transaction information. The root of the Merkle tree may refer to a finally generated single hash reference.

The timestamp may indicate the time when a work starts for proof of the work. The difficulty may mean a constraint in the proof of work or hash puzzles. The nonce may mean a value that is adjusted such that the value of the block hash satisfies the constraint for the proof of work.

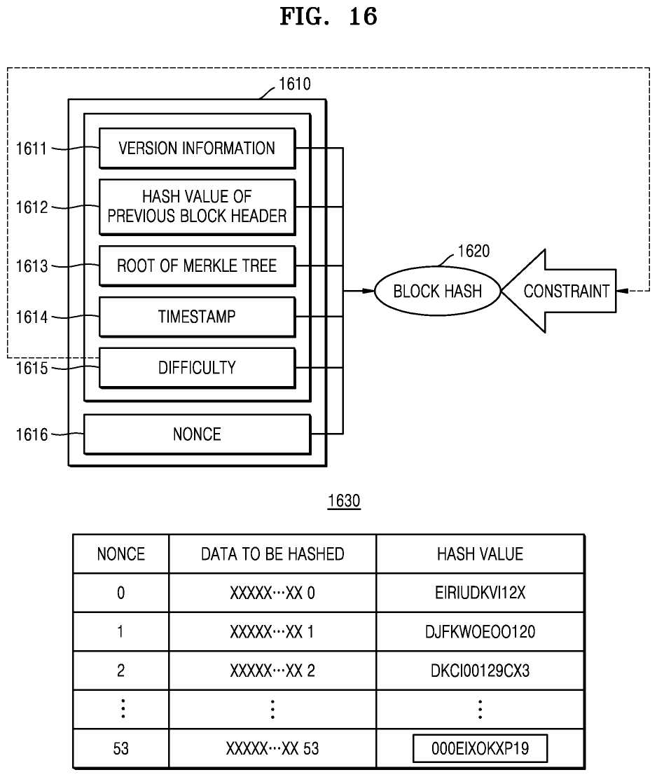

FIG. 16 is a diagram illustrating a method performed by a node on a network of blockchain of obtaining a proof of work and a nonce of a block according to an embodiment.

Nodes on the network of blockchain may verify the validity of transaction information and the validity of a block header such that a valid block including only data of valid transaction information and the block header may be connected to blockchain.

Each node may perform the proof of work on the block to generate the valid block. Here, the proof of work may mean solving a unique hash puzzle of the block.

An element 1610 for the proof of work may include given data that should not be changed, freely changeable data, a hash function to be applied, and a constraint given to a hash value. Here, the given data that should not be changed may include version information 1611, a hash value 1612 of a previous block header, a root of a Merkle tree 1613, a timestamp 1614, and data about a difficulty 1615. Further, the freely changeable data may be a nonce 1616. Also, the constraint given to the hash value may be the difficulty 1615.

As shown in FIG. 16, the proof of work may be performed when a value of a block hash 1620 generated by applying the hash function to the version information 1611, the hash value 1612 of the previous block header, the root of a Merkle tree 1613, the timestamp 1614, the data about the difficulty 1615, and the nonce 1616 satisfies the constraint.

Specifically, the node may generate the value of the block hash 1620 by guessing the nonce 1616, combining the guessed nonce 1616 with the version information 1611, the hash value 1612 of the previous block header, the root of a Merkle tree 1613, the timestamp 1614, and the data about the difficulty 1615, and applying the hash function, for the proof of work on the block. The node may confirm whether the generated value of the block hash 1620 satisfies the constraint. If the value of the block hash 1620 satisfies the constraint, the proof of work is completed, but if the value of the block hash 1620 does not satisfy the constraint, the node may repeat the same process after guessing another nonce.

A table 1630 of FIG. 16 shows nonces, data to be hashed, and hash values generated by combining the nonces and the data to be hashed and applied to the hash function. For example, the constraint may be a condition in which first three digits of the hash value are 0. The node may perform a process for the proof of work while increasing the nonce from 0 by 1. Referring to the table 1630 of FIG. 16, a hash value (000EIXOKXP19) generated using a nonce 53 satisfies the constraint. The node may complete the proof of work in 54 trials and errors from a nonce 0 to the nonce 53.

The difficulty 1615 may mean a constraint in the proof of work or hash puzzles. The difficulty 1615 may be expressed as a natural number, and the number of the difficulty 1615 may mean the number of digits to be filled with 0 from a first digit of the hash value. Therefore, as the difficulty 1615 increases, the number of first digits to be filled with 0 increases. As the difficulty 1615 increases, the proof of work or hash puzzles is complex, and more computational resources and time may be required to find a nonce that satisfies the constraint.

That is, the proof of work may mean calculating a nonce value to obtain a value of the block hash, and generating a valid block having the obtained value of the block hash as an identifier. Meanwhile, the node that generates the valid block may be rewarded. Reward may be determined with the agreement of nodes on the network of blockchain.

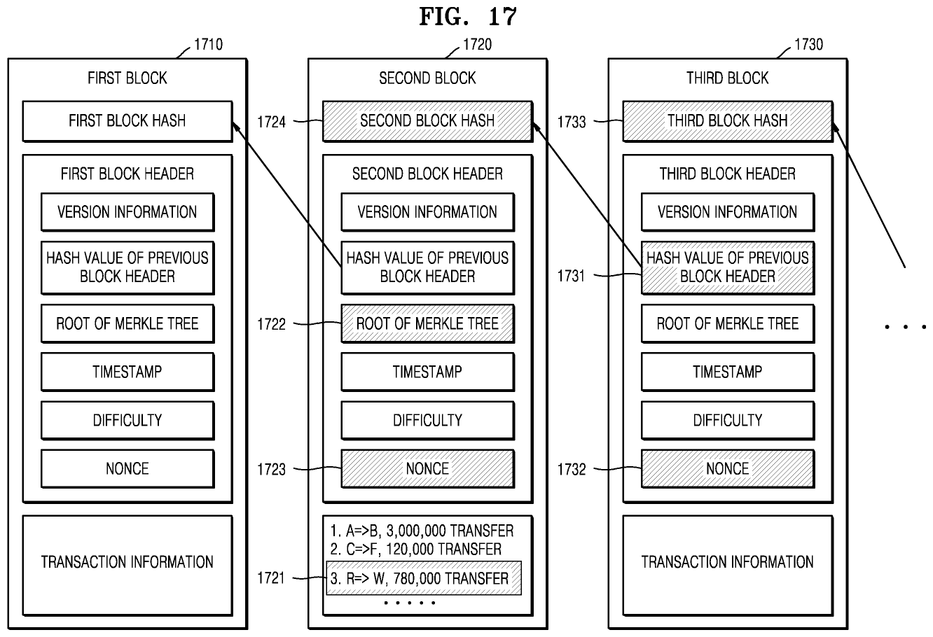

FIG. 17 is a diagram illustrating an effect of increasing consistency and security of transaction information by recording the transaction information on blockchain according to an embodiment.

A hash value of the transaction information may be used to calculate a root of a Merkle tree of a block including the transaction information. Also, the root of the Merkle tree may be used to calculate a value of a block hash. The value of the block hash may be used as an input value to calculate a value of a block hash of a next block.

Specifically, the hash value of the transaction information of a second block 1720 may be used as an input value to calculate the root of the Merkle tree of the second block 1720. Also, version information of a second block header, a hash value of a block header of a first block 1710, a root 1722 of the Merkle tree, a timestamp, a difficulty, and a nonce 1723 may be applied to a hash function as input values and thus, a second block hash 1724 that is a hash value of the second block header may be calculated. The second block hash 1724 may be used to calculate a hash value of a block header 1732 of a third block 1730.

Thus, as illustrated in FIG. 17, when predetermined transaction information 1721 among the transaction information of the second block 1720 is changed, the root 1722 of the Merkle tree of the second block header may be changed. When the root 1722 of the Merkle tree of the second block header is changed, the nonce 1723 of the second block header may be changed. Because the root 1722 of the Merkle tree of the second block header and the nonce 1723 of the second block header are changed, the second block hash 1724 may also be changed. Further, as the second block hash 1724 is changed, a hash value 1731 of a previous block header of the third block 1730, a nonce 1732, and a third block hash 1733 may also be changed. That is, when the transaction information recorded in the block is changed, because the root of the Merkle tree and nonce recorded in the block are changed, the hash value of the block header must be recalculated. Then, the hash value of the block header of the next block must also be recalculated. Therefore, while the transaction information is changed in a predetermined node, and a proof of work is performed from a block including the changed transaction information blocks, blocks may be continuously added to blockchain where the transaction information has not changed in other nodes. Therefore, the length of blockchain possessed by the predetermined node is smaller than the length of blockchain possessed by other nodes.

Meanwhile, nodes on the network of blockchain may select history of the transaction information according to a predetermined criterion in order to provide consistency and security of the history of the transaction information recorded on blockchain. For example, the predetermined criterion may be selecting a path having the most blocks among tree-shape blockchain data structures. In addition, the predetermined criterion may be selectomg a path having the largest difficulty summation among the tree-shape blockchain data structures.

Therefore, the length of blockchain having a block with changed transaction information is shorter than the length of blockchain with unchanged transaction information, nodes on the network of blockchain may select the blockchain with unchanged transaction information, and thus consistency and security of the history of the transaction information recorded on the blockchain may be guaranteed.

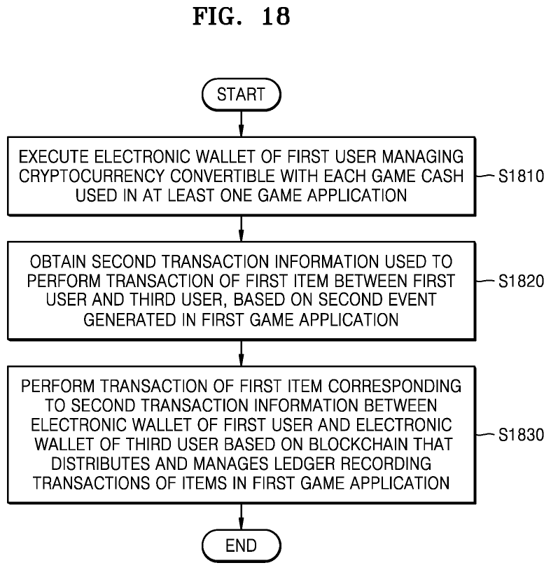

FIG. 18 is a diagram illustrating an operation of an electronic device that performs a transaction of items corresponding to transaction information based on blockchain according to an embodiment.

In operation S1810, the electronic device 10 may execute an electronic wallet of a first user managing cryptocurrency convertible with each game cash used in at least one game application.

In operation S1820, the electronic device 10 may obtain second transaction information used to perform the transaction of a first item of a first game application between the first user and a third user. The transaction of the first item between the first user and the third user may be determined based on a second event generated in the first game application. Here, the second event may be generated by a predetermined action between the first user and the third user while the first game application is being executed.

For example, the second event may be a result of a betting game between the first user and the third user in the first game application. In the betting game, betting may mean that a user who lost the game sells a predetermined item to a user who wins the game at a predetermined price.

The second transaction information may include at least one of address information of an electronic wallet of the first user, address information of an electronic wallet of the second user, information of a user who wants to sell the first item, information of an amount of money to sell the first item, time information of the first item to sell, information of a fee according to the sale of the first item, and information proving the consent of the user to sell the first item.

The electronic device 10 may obtain the second transaction information based on at least one of user input information received from a user interface device of the electronic device 10, transfer history information transacted in an electronic wallet, and information of a second event obtained from a server managing the first game application.

In operation S1830, the electronic device 10 may perform a transaction of the first item corresponding to the second transaction information between the electronic wallet of the first user and the electronic wallet of the third user based on a second blockchain that distributes and manages a ledger recording the transaction of items in the first game application.

Specifically, the electronic device 10 may perform the transaction of cryptocurrency corresponding to the first item between the electronic wallet of the first user and the electronic wallet of the third user according to the second transaction information. Also, the electronic device 10 may request an ownership transfer of the first item from a server of the first game application according to the second transaction information. The electronic device 10 may request a second node 20-2′ on the network of the second blockchain to record the second transaction information on the block in order to verify the transaction of the first item. The electronic device 10 may complete the transaction of the first item corresponding to the second transaction information by receiving a message indicating that the transaction of the first item has been verified from the network of the second blockchain.

The electronic device 10 may ensure the security of the transaction of the item of the game application by performing the transaction of the item of the game application between the first user and the second user based on blockchain.

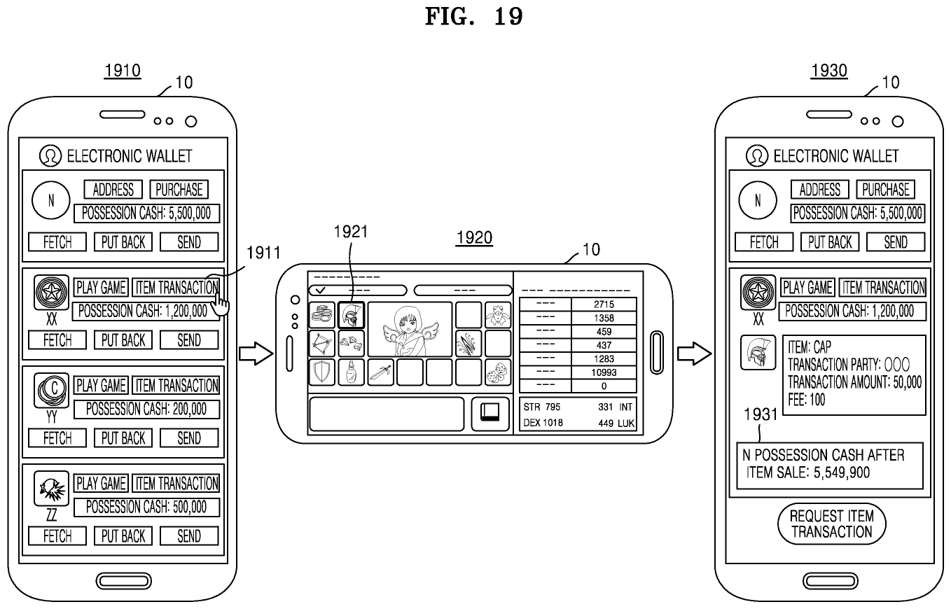

FIG. 19 is a diagram illustrating a process in which an electronic device transacts items in a game application according to an embodiment.

Referring to 1910 of FIG. 19, the electronic device 10 may display information of cryptocurrency possessed in an electronic wallet of a first user according to the execution of the electronic wallet of the first user. Also, the electronic device 10 may display the balance information of game cash used in each of game applications having an account of the first user. In addition, the electronic device 10, may display icons capable of fetching game cash from cryptocurrency, putting the game cash back to the cryptocurrency, sending the game cash to another user, and performing the transaction of game items, with respect to each of the game applications having the account of the first user. The electronic device 10 may receive an input for selecting an icon 1911 that guides to perform an item transaction of an XX game application.

Referring to 1920 of FIG. 19, the electronic device 10 may execute the XX game application to display a list including items owned in the account of the first user. The electronic device 10 may receive an input for selecting a cap item 1921 in the list.

Referring to 1930 of FIG. 19, the electronic device 10 may receive information required to perform a transaction in which the first user sells the cap item 1921 of the XX game application to the third user. For example, the electronic device 10 may receive information of the third user who purchases the cap item 1921, information about a transaction amount of the cap item 1921, etc. The electronic device 10 may also display balance information 1931 of cryptocurrency after the sale of the cap item 1921. When an input for requesting the item transaction is received, the electronic device 10 may perform the transaction of the cap item 1921.

Specifically, the electronic wallet of the first user executed in the electronic device 10 may receive cryptocurrency 49,900 cash from the electronic wallet of the third user. Here, the cryptocurrency 49,900 cash is cash excluding fee 100 cash from cryptocurrency 50,000 cash which is the transaction amount of the cap item 1921. Also, the electronic device 10 may request the server of the XX game application to transfer the ownership of the cap item 1921 to the third user.

Meanwhile, a fee for transferring an item may be generated whenever the first user transfers the item to another user. In addition, the fee may be determined based on the number of transfers of items of the first user, the transaction amount of items, the transaction time of items, etc. For example, if the number of transfers of items of the first user is more than a predetermined number of times per month, a fee of 20% discount amount may apply. For another example, an amount corresponding to a period to which the transaction amount of items belongs among preset periods may be applied to a fee. In this case, the higher the transaction amount, the higher the amount of the fee. As another example, if the first user applies for a reservation transfer for the transaction of items in advance, a predetermined discount rate may be applied to the fee. In addition, a fee for transactions of items between the same kind of game applications may be lower than a fee for transactions of items between different kinds of game applications. Also, the fee may be paid as a game cash in a game application having an account of the first user.

The fee incurred in the transaction of items may be distributed as rewards to nodes on the network of blockchain that distributes and manages a ledger recording the transaction for items. By paying fees as rewards to the nodes on the network of blockchain, it is possible to achieve the integrity of blockchain and increase the work efficiency of the nodes.

In addition, in the case of blockchain that utilizes a distributed system but utilizes a centralized control system with partial access restrictions, the fee incurred in the transaction of items may be paid to a server that controls blockchain.

The electronic device 10 may request the node on the network of the XX blockchain that distributes and manages the ledger recording the transaction of items in the XX game application to record transaction information of the cap item 1921 on the block. The electronic device 10 may complete the transaction of the cap item 1921 by receiving a message indicating that the transaction of the cap item 1921 has been verified from the network of the XX blockchain.

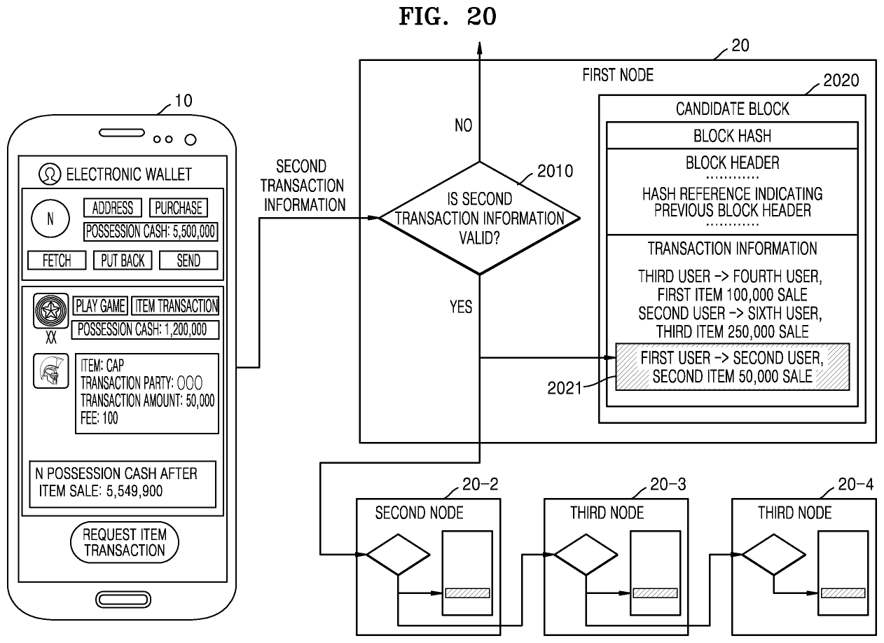

FIG. 20 is a diagram illustrating a process of propagating a transaction of an item valid on the network of blockchain to nodes on the network of blockchain and recording the transaction on the blockchain according to an embodiment.

As described with reference to FIG. 19, the electronic device 10 may receive cryptocurrency 49,900 cash from the an electronic wallet of a third user and request a server of an XX game application to transfer ownership of a cap item to the third user based on second transaction information that the first user sells the cap item of the XX game application to the third user.

Referring to FIG. 20, the electronic device 10 may encrypt the second transaction information and transmit the encrypted second transaction information to a first node 20′ on the network of an XX blockchain. Specifically, the electronic device 10 may apply the second transaction information that the first user sells the cap item of the XX game application to the third user to a hash function that generates unique data of the transaction information to generate a second hash value corresponding to the second transaction information. The electronic device 10 may encrypt the second hash value with a private key of the first user to generate a second cryptogram indicating a digital signature of the second transaction information. The electronic device 10 may transmit the second cryptogram along with the second transaction information to the first node 20′.

The first node 20′ may decrypt the encrypted second transaction information and verify whether the second transaction information is valid based on a decryption result. The first node 20′ may apply a hash function to the second transaction information to generate a second hash value′ corresponding to the second transaction information. Further, the first node 20′ may decrypt a second cryptogram using a public key of the first user to generate a second hash value″. If the second hash value′ and the second hash value″ are the same, the first node 20′ may determine that the second transaction information received from the electronic device 10 is valid. Meanwhile, if the second hash value′ and the second hash value″ are not the same, the first node 20′ may determine that the second transaction information received from the electronic device 10 is invalid.

As a result of verifying the validity of the second transaction information, if the second transaction information is invalid, the first node 20′ may discard the second transaction information.

As a result of verifying the validity of the second transaction information, if the second transaction information is valid, the first node 20′ may transmit the second transaction information to the second node 20-2′ on the network of the XX blockchain. Also, the first node 20′ may record the second transaction information that the first user sells the cap item to the third user on a candidate block. When predetermined transaction information is recorded on the candidate block, the first node 20′ may perform a proof of work on the candidate block to generate a valid block. The first node 20′ may add the valid block to blockchain possessed by the first node 20′. Also, the first node 20′ may transmit a valid block to other nodes on the network of the XX blockchain.

Likewise, when the validity of the second transaction information is verified in the second node 20-2′, the second node 20-2′ may add the second transaction information to the candidate block and perform the proof of work on the candidate block to generate a valid block. A third node 20-3′ and a fourth node 20-4′ may operate in the same manner as the second node 20-2′.

In addition, the nodes 20-2′, 20-3′, 20-4′, etc. on the network of the XX blockchain may perform verification on the valid block received from the first node 20′ to respectively add valid blocks to blockchains possessed by the nodes 20-2′, 20-3′, 20-4′, etc.

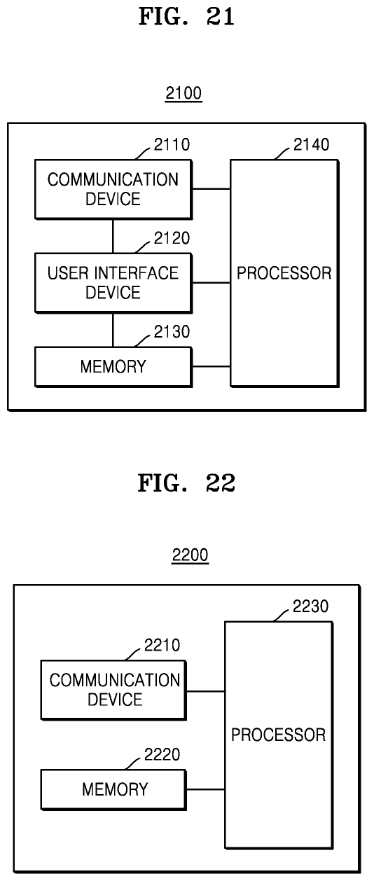

FIG. 21 is a block diagram illustrating the configuration of an electronic device according to an embodiment.

An electronic device 2100 illustrated in FIG. 21 may include a communication device 2110, a user interface device 2120, a memory 2130, and a processor 2140. However, all of the illustrated components are not indispensable components. The electronic device 2100 may be implemented by more components than the illustrated components, and the electronic device 2100 may also be implemented by fewer components. Hereinafter, the components will be described. The electronic device 2100 illustrated in FIG. 21 may correspond to the electronic device 10 described with reference to FIGS. 1 to 20.

According to some embodiments, the communication device 2110 may communicate with an external device. Specifically, the communication device 2110 may be connected to a network by wired or wirelessly to perform communication with the external device. Here, the external device may be a server, a smartphone, a tablet, a PC, or a computing device. The communication device 2110 may include a communication module supporting one of various wired/wireless communication methods. For example, the communication module may be in the form of a chipset, or may be a sticker/barcode (e.g. a sticker including an NFC tag) including information necessary for communication. Further, the communication module may be a short-range communication module or a wired communication module.

For example, the communication device 2110 may support at least one of a wireless LAN, Wi-Fi (Wireless Fidelity), WFD (Wi-Fi Direct), Bluetooth, Bluetooth Low Energy (BLE), Wired LAN, NFC Near Field Communication, Zigbee, infrared data association (IrDA), 3G, 4G, and 5G.

According to some embodiments, the electronic device 2100 may communicate with at least one node on the network of blockchain that distributes and manages a ledger that records transactions of cryptocurrency. For example, the electronic device 2100 may transmit transaction information of cryptocurrency transacted between a first user and a second user to the first node 20.

According to some embodiments, the user interface device 2120 may refer to a device that receives data to control the electronic device 2100 from a user. The processor 2140 may control the user interface device 2120 to generate and output a user interface screen for receiving a predetermined command or data from the user. The user interface device 2120 may include an input unit for receiving an input for controlling the operation of the electronic device 2100, and an output unit for displaying information such as a result of the operation of the electronic device 2100 or the state of the electronic device 2100. For example, the user interface device 2120 may include an operation panel receiving a user input, a display panel displaying a screen, etc.

Specifically, the input unit may include devices capable of receiving various types of user input, for example, a keyboard, a physical button, a touch screen, a camera, or a microphone. Also, the output unit may include, for example, a display panel or a speaker. However, the present disclosure is not limited thereto, and the user interface device 2120 may include a device supporting various input/output.

According to some embodiments, the user interface device 2120 may display an execution screen of an electronic wallet of the first user. For example, the user interface device 2120 may display information of cryptocurrency possessed in the electronic wallet of the first user, and information of game cash used in at least one game application having an account of the first user. Also, the user interface device 2120 may display a screen executed by the first user to transact cryptocurrency with another user.

The memory 2130 may include at least one type storage medium of a flash memory type, a hard disk type, a multimedia card micro type, a card type memory (e.g., SD or XD memory, etc.), random access memory (RAM), static random access memory (SRAM), read only memory (ROM), electrically erasable programmable read-only memory (EEPROM), programmable read-only memory (PROM), a magnetic memory, a magnetic disk, or an optical disk. The memory 2130 may store at least one program for executing a method of controlling an operation of an electronic wallet executed in the electronic device 2100 on a computer. The at least one program stored in the memory 2130 may be classified into a plurality of modules according to functions.

The processor 2140 may control the overall operation of the electronic device 2100, and may include at least one processor such as a CPU. The processor 2140 may control other components included in the electronic device 2100 to perform an operation corresponding to a user input received through the user interface device 2120. Further, the processor 2140 may include at least one specialized processor corresponding to each function, or may be a processor integrated into one.

The processor 2140 may execute a program stored in the memory 2130, read data or a file stored in the memory 2130, or store a new file in the memory 2130. Also, the processor 2140 may execute instructions stored in the memory 2130.

According to some embodiments, the processor 2140 may execute the electronic wallet of the first user managing cryptocurrency. Here, the cryptocurrency may be interconvertible with each game cash used in at least one game application executed in the electronic device 2100.

According to some embodiments, the processor 2140 may obtain first transaction information used to perform a transaction of cryptocurrency between the first user and a second user. Here, the transaction of cryptocurrency between the first user and the second user may be determined based on a first event generated in a first game application. Also, the processor 2140 may obtain the first transaction information based on user input information received through the user interface device 2120. In addition, the processor 2140 may obtain the first transaction information based on at least one of transfer history information transacted in the electronic wallet, and information of the first event obtained from a server managing the first game application.

For example, the first transaction information may include at least one of address information of an electronic wallet of the first user, address information of an electronic wallet of the second user, information of a user who is to transfer cryptocurrency, information of the transfer amount of cryptocurrency to be transferred, time information of cryptocurrency to be transferred, information about fees according to the transfer of cryptocurrency, and information proving whether the user who is to transfer cryptocurrency agrees to transfer cryptocurrency.

According to some embodiments, the processor 2140 may perform the transaction of cryptocurrency corresponding to the first transaction information between the electronic wallet of the first user and the electronic wallet of the second user, based on blockchain that distributes and manages a ledger recording the transaction of cryptocurrency.

According to some embodiments, the processor 2140 may display information of cryptocurrency possessed in the electronic wallet of the first user and information of a game cash used in each of the at least one game application having the account of the first user through the user interface device 2120. For example, the processor 2140 may display information about the balance of the game cash owned in the account of the first user, an icon used to manage the owned game cash, and an icon for executing the game application with respect to each of the at least one game application through the user interface device 2120.

According to some embodiments, the processor 2140 may receive an input of the first user that controls to interconvert between first game cash owned in the account of the first user and cryptocurrency through the user interface device 2120. The processor 2140 may interconvert between cryptocurrency and the first game cash based on the input of the first user and an exchange rate between cryptocurrency and the first game cash.

According to some embodiments, the processor 2140 may control to perform the transaction of cryptocurrency between the electronic wallet of the first user and the electronic wallet of the second user according to the first transaction information. The processor 2140 may request the first node 20 on the network of blockchain to record the first transaction information on a block constituting blockchain through the communication device 2110. The processor 2140 may complete the transaction of the cryptocurrency corresponding to the first transaction information by receiving a message indicating that the transaction of the cryptocurrency has been verified from the network of blockchain through the communication device 2110.

According to some embodiments, the processor 2140 may encrypt the first transaction information and transmit the encrypted first transaction information to the first node 20 through the communication device 2110. Specifically, the processor 2140 may apply the first transaction information to a hash function for generating unique data of the first transaction information to generate a first hash value corresponding to the first transaction information. The processor 2140 may encrypt the first hash value with a private key of the first user to generate a first cryptogram indicating a digital signature of the first transaction information. The processor 2140 may transmit the first cryptogram along with the first transaction information to the first node 20 through the communication device 2110.

According to some embodiments, when a second event that satisfies the predetermined condition is performed in the first game application, the processor 2140 may receive the cryptocurrency from a server of the first game application.

According to some embodiments, when an event is generated in which the first user must compensate the second user for cryptocurrency according to an operation between the first user and the second user performed in the first game application, the processor 2140 may receive a message requesting transfer of a predetermined amount of cryptocurrency to an electronic wallet of the second user from a server of the first game application through the communication device 2110. When the user interface device 2120 receives an input for authorizing the transfer of the predetermined amount of cryptocurrency, the processor 2140 may transfer the predetermined amount of cryptocurrency from an electronic wallet of the first user to the electronic wallet of the second user based on blockchain.

According to some embodiments, the first transaction information is information that the first user transfers a predetermined amount of cryptocurrency to the second user, and the predetermined amount of cryptocurrency may be greater than the possession amount of cryptocurrency possessed in the electronic wallet of the first user. In this case, the processor 2140 may convert the first game cash of the first game application into the cryptocurrency by a difference between the predetermined amount of cryptocurrency and the possession amount of cryptocurrency. The processor 2140 may convert the first game cash of the first game application into cryptocurrency based on an input of the first user. In addition, the processor 2140 may automatically convert the first game cash of the first game application into cryptocurrency in consideration of at least one game cash owned in the account of the first user.

According to some embodiments, the processor 2140 may obtain second transaction information used to perform the transaction of a first item of the first game application between the first user and a third user. Here, the transaction of the first item of the first game application between the first user and the third user may be determined based on a second event generated in the first game application.

According to some embodiments, the processor 2140 may perform a transaction of the first item corresponding to the transaction information between the electronic wallet of the first user and an electronic wallet of the third user based on a second blockchain that distributes and manages a ledger recording the transaction of items in the first game application.

Specifically, the processor 2140 may control to perform the transaction of cryptocurrency corresponding to the first item between the electronic wallet of the first user and the electronic wallet of the third user according to the second transaction information. The processor 2140 may request an ownership transfer of the first item to the server of the first game application according to the second transaction information through the communication device 2110. For example, when the first user sells the first item to the third user, the processor 2140 may request the ownership transfer of the first item from the server of the first game application. The processor 2140 may request the second node 20-2′ on the network of a second blockchain to record the second transaction information on a block constituting the second blockchain through the communication device 2110. The communication device 2110 may receive a message indicating that the transaction of the first item has been verified from the network of the second blockchain and complete the transaction of the first item corresponding to the second transaction information.

In addition, when the second transaction information is information used to transact a part of the first item between the first user and the third user, the processor 2140 may perform transaction of cryptocurrency corresponding to the part of the first item between the electronic wallet of the first user and the electronic wallet of the third user. Further, the processor 2140 may request an ownership transfer of the part of the first item to the server of the first game application according to the second transaction information through the communication device 2110.

FIG. 22 is a block diagram illustrating the configuration of a node on the network of blockchain according to an embodiment.

A node 2200 illustrated in FIG. 22 may include a communication device 2210, a memory 2220, and a processor 2230. However, all of the illustrated components are not indispensable components. The node 2200 may be implemented by more components than the illustrated components, and the node 2200 may also be implemented by fewer components. Hereinafter, the components will be described. The node 2200 illustrated in FIG. 22 may correspond to the node 20 described with reference to FIGS. 1 to 20.

According to some embodiments, the communication device 2210 may communicate with an external device. Specifically, the communication device 2210 may be connected to a network by wired or wirelessly to perform communication with the external device. Here, the external device may be a server, a smartphone, a tablet, a PC, or a computing device. The communication device 2210 may include a communication module supporting one of various wired/wireless communication methods. For example, the communication module may be in the form of a chipset, or may be a sticker/barcode (e.g. a sticker including an NFC tag) including information necessary for communication. Further, the communication module may be a short-range communication module or a wired communication module.

According to some embodiments, the memory 2220 may include at least one type storage medium of a flash memory type, a hard disk type, a multimedia card micro type, a card type memory (e.g., SD or XD memory, etc.), random access memory (RAM), static random access memory (SRAM), read only memory (ROM), electrically erasable programmable read-only memory (EEPROM), programmable read-only memory (PROM), a magnetic memory, a magnetic disk, or an optical disk. The memory 2220 may store at least one program for executing a method of operating the node 2200 on a network of blockchain that distributes and manages a ledger that records transactions of cryptocurrency on a computer. The at least one program stored in the memory 2220 may be classified into a plurality of modules according to functions.

According to some embodiments, the processor 2230 may control the overall operation of an electronic device, and may include at least one processor such as a CPU. The processor 2230 may include at least one specialized processor corresponding to each function, or may be a processor integrated into one.

The processor 2230 may execute a program stored in the memory 2220, read data or a file stored in the memory 2220, or store a new file in the memory 2220. Also, the processor 2230 may execute instructions stored in the memory 2220.

According to some embodiments, the processor 2230 may receive first transaction information of cryptocurrency transacted between a first user and a second user from the electronic device through the communication device 2210. Here, the first transaction information may be determined based on a first event generated in a first game application. In addition, the processor 2230 may receive information of the first event from a server managing the first game application.

According to some embodiments, the processor 2230 may verify the validity of the first transaction information based on the first transaction information and the information of the first event. If the first transaction information is valid, the processor 2230 may transmit the first transaction information to the second node on the network of blockchain that distributes and manages the ledger that records transactions of cryptocurrency through the communication device 2210. In addition, the processor 2230 may add the first transaction information to a candidate block. If the first transaction information is invalid, the processor 2230 may discard the first transaction information.

According to some embodiments, the processor 2230 may perform a proof of work on the candidate block to add the candidate block to blockchain as a valid block.

According to some embodiments, the processor 2230 may receive the first transaction information that the first user transfers a predetermined amount of cryptocurrency to the second user and a first cryptogram indicating a digital signature of the first transaction information from the electronic device through the communication device 2210.

According to some embodiments, the processor 2230 may apply the first transaction information to a hash function to generate a first hash value corresponding to the first transaction information. The processor 2230 may decrypt the first cryptogram using a public key of the first user to generate a second hash value. The processor 2230 may verify the validity of the first transaction information based on a result of comparing the first hash value with the second hash value and whether the information of the first event corresponds to the first transaction information.

According to some embodiments, the processor 2230 may receive a first block on which proof of work is completed from the second node on the network of blockchain through the communication device 2210. The processor 2230 may verify the validity of the first block by confirming the validity of at least one transaction information included in the first block and the validity of a block header of the first block. If the first block is valid, the processor 2230 may add the first block to the blockchain of the node 2200. Meanwhile, if the first block is invalid, the processor 2230 may discard the first block and generate a valid block to be added to the blockchain of the node 2200.

The processor 2230 may receive, from the electronic device, second transaction information of the first item of the first game application transacted between the first user and the third user through the communication device 2210. Here, the second transaction information of the first item of the first game application may be determined based on the second event generated in the first game application. Also, the processor 2230 may receive information about the second event from a server managing the first game application through the communication device 2210.

According to some embodiments, the processor 2230 may verify the validity of the second transaction information based on the second transaction information and the information about the second event. When the second transaction information is valid, the processor 2230 may transmit the second transaction information to the second node 20-2′ on the network of a second blockchain that distributes and manages a ledger recording transactions of items in the first game application through the communication device 2210. Also, the processor 2230 may add the second transaction information to the candidate block. Meanwhile, if the second transaction information is invalid, the processor 2230 may discard the second transaction information.

According to some embodiments, the processor 2230 may perform the proof of work on the candidate block, and add the candidate block to the second blockchain as a valid block.

The device described above may be realized as hardware elements, software elements, and/or the combination of hardware elements and software elements. For example, the device and the components described in the embodiments may be realized by using, for example, a processor, an arithmetic logic unit (ALU), a digital signal processor, a microcomputer, a field programmable gate array (FPGA), a programmable logic unit (PLU), a microprocessor, or one or more general-purpose computers or special-purpose computers, such as a device capable of executing and responding to instructions. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

As described above, although the embodiments have been described by the limited embodiment and drawings, it will be apparent to one of ordinary skill in the art that various changes in form and details may be made in these examples without departing from the spirit and scope of the claims and their equivalents. For example, suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

1. A method of controlling operation of an electronic wallet executed in an electronic device, the method comprising:
executing an electronic wallet of a first user managing cryptocurrency convertible with each game cash used in at least one game application executed on the electronic device;
obtaining first transaction information used to perform a transaction of cryptocurrency between the first user and a second user based on a first event generated within the at least one game application; and
based on a blockchain that distributes and manages a ledger recording transactions of the cryptocurrency, performing the transaction of the cryptocurrency corresponding to the first transaction information between the electronic wallet of the first user and an electronic wallet of the second user.

2. The method of claim 1, further comprising:
displaying information of cryptocurrency possessed in the electronic wallet of the first user according to an execution of the electronic wallet of the first user and information of a game cash used in each of at least one game application having an account of the first user.

3. The method of claim 1, further comprising:
receiving an input of the first user that controls interconversion between a first game cash, which is owned in the account of the first user in a first game application among the at least one game application, and the cryptocurrency; and
interconverting between the cryptocurrency and the first game cash based on the input of the first user and an exchange rate between the cryptocurrency and the first game cash.

4. The method of claim 1, wherein the first transaction information comprises at least one of address information of the electronic wallet of the first user, address information of the electronic wallet of the second user, information of a user who is to transfer the cryptocurrency, information of a transfer amount of the cryptocurrency to be transferred, time information of the cryptocurrency to be transferred, information about a fee according to a transfer of the cryptocurrency, and information proving whether the user who is to transfer the cryptocurrency agrees to the transfer of the cryptocurrency.

5. The method of claim 1, wherein the performing of the transaction of the cryptocurrency corresponding to the first transaction information, based on the blockchain, comprises:
performing the transaction of the cryptocurrency between the electronic wallet of the first user and the electronic wallet of the second user according to the first transaction information;
requesting a first node on a network of the blockchain to record the first transaction information on a block constituting the blockchain in order to verify the transaction of the cryptocurrency; and
receiving a message indicating that the transaction of the cryptocurrency has been verified from the network of the blockchain, to thereby complete the transaction of the cryptocurrency corresponding to the first transaction information.

6. The method of claim 5, wherein the requesting of the first node on the network of the blockchain to record the first transaction information comprises:
encrypting the first transaction information and transmitting the encrypted first transaction information to the first node.

7. The method of claim 6, wherein the transmitting of the encrypted first transaction information to the first node comprises:
generating a first hash value corresponding to the first transaction information by applying the first transaction information to a hash function for generating unique data of the first transaction information;
generating a first cryptogram indicating a digital signature of the first transaction information by encrypting the first hash value with a private key of the first user; and
transmitting the first cryptogram along with the first transaction information to the first node.

8. The method of claim 1, further comprising:
based on a second event generated in a first game application among the at least one game application, performing the transaction of the cryptocurrency between a provider providing a service of the first game application and the first user.

9. The method of claim 8, wherein the performing of the transaction of the cryptocurrency between the provider providing the service of the first game application and the first user comprises:
receiving a message indicating that the second event has been performed in the first game application from a server of the provider; and
receiving the cryptocurrency from the server of the provider in the electronic wallet of the first user.

10. The method of claim 8, wherein the second event is an event in which an action that satisfies a condition proposed by the provider is performed in the first game application.

11. The method of claim 2, wherein the displaying of the information of the cryptocurrency possessed in the electronic wallet of the first user according to the execution of the electronic wallet of the first user and the information of the game cash used in each of the at least one game application having the account of the first user comprises:
displaying information about a balance of the game cash owned in the account of the first user, an icon used to manage the owned game cash, and an icon for executing the game application with respect to each of the at least one game application.

12. The method of claim 1, wherein the obtaining of the first transaction information comprises:
when an event is generated in which the first user must compensate the second user for the cryptocurrency according to an operation between the first user and the second user performed in a first game application among the at least one game application, receiving a message requesting a transfer of a predetermined amount of the cryptocurrency to the electronic wallet of the second user from a server of the first game application, and
the performing of the transaction of the cryptocurrency corresponding to the first transaction information comprises:
when an input for authorizing the transfer of the predetermined amount of the cryptocurrency is received, transferring the predetermined amount of the cryptocurrency from the electronic wallet of the first user to the electronic wallet of the second user based on the blockchain.

13. The method of claim 1, further comprising:
when the first transaction information is information of the first user transferring the predetermined amount of the cryptocurrency to the second user, and the predetermined amount of cryptocurrency is greater than a possession amount of the cryptocurrency possessed in the electronic wallet of the first user,
converting a game cash of the at least one game application into the cryptocurrency by as much as a difference between the predetermined amount of the cryptocurrency and the possession amount of the cryptocurrency.

14. The method of claim 1, further comprising:
based on a second event generated in a first game application among the at least one game application, obtaining second transaction information used to perform a transaction of a first item of the first game application between the first user and a third user; and
performing the transaction of the first item corresponding to the second transaction information between the electronic wallet of the first user and an electronic wallet of the third user based on a second blockchain that distributes and manages a ledger recording transactions of items in the first game application.

15. The method of claim 14, wherein the performing of the transaction of the first item corresponding to the second transaction information comprises:
performing a transaction of the cryptocurrency corresponding to the first item between the electronic wallet of the first user and the electronic wallet of the third user, according to the second transaction information;
requesting an ownership transfer of the first item from a server of the first game application, according to the second transaction information;
requesting a second node on a network of the second blockchain to record the second transaction information on a block constituting the second blockchain, in order to verify the transaction of the first item; and
receiving a message indicating that the transaction of the first item has been verified from the network of the second blockchain, to thereby complete the transaction of the first item corresponding to the second transaction information.

16. The method of claim 15, wherein when the second transaction information is information used to transact a part of the first item between the first user and the third user, the performing of the transaction of the cryptocurrency corresponding to the first item between the electronic wallet of the first user and the electronic wallet of the third user according to the second transaction information comprises:
performing a transaction of the cryptocurrency corresponding to the part of the first item between the electronic wallet of the first user and the electronic wallet of the third user according to the second transaction information; and
requesting an ownership transfer of the part of the first item from the server of the first game application according to the second transaction information.

17. A method of controlling operation of an electronic wallet executed in an electronic device, the method comprising:
executing an electronic wallet of a first user managing cryptocurrency convertible with each game cash used in at least one game application executed on the electronic device;
displaying information of the electronic wallet of the first user comprising information of cryptocurrency possessed in the electronic wallet of the first user according to execution of the electronic wallet of the first user and information of a game cash used in each of at least one game application having an account of the first user; and
performing a transaction of the cryptocurrency based on the information of the electronic wallet of the first user.

18. A method of controlling operation of an electronic wallet executed in an electronic device, the method comprising:
executing an electronic wallet of a first user managing cryptocurrency convertible with each game cash used in at least one game application executed on the electronic device;
based on an event generated in a first game application among the at least one game application, obtaining transfer information used to perform a transaction of the cryptocurrency between a provider providing a service of the first game application and the first user; and
based on a blockchain that distributes and manages a ledger recording transactions of the cryptocurrency, performing the transaction of the cryptocurrency corresponding to the transaction information.

19. A computer-readable recording medium having recorded thereon a program for executing the method of claim 1 on a computer.

20. An electronic device comprising:
a communication device;
a processor;
a user interface device; and
a memory storing instructions executable by the processor,
wherein the processor is configured to, by executing the instructions,
execute an electronic wallet of a first user managing cryptocurrency convertible with each game cash used in at least one game application executed on the electronic device;
obtain first transaction information used to perform a transaction of cryptocurrency between the first user and a second user based on a first event generated within the at least one game application; and
based on a blockchain that distributes and manages a ledger recording transactions of the cryptocurrency, perform the transaction of the cryptocurrency corresponding to the first transaction information between the electronic wallet of the first user and an electronic wallet of the second user.

21. An operation method of a first node on a network of a blockchain that distributes and manages a ledger that records transactions of cryptocurrency, the operation method comprising:
receiving, from an electronic device, first transaction information of the cryptocurrency transacted between a first user and a second user based on a first event generated in a first game application;
receiving information of the first event from a server managing the first game application;
verifying validity of the first transaction information based on the first transaction information and the information of the first event;
if the first transaction information is valid, transmitting the first transaction information to a second node on the network of the blockchain, and adding the first transaction information to a candidate block; and
performing proof of work on the candidate block, and adding the candidate block to the blockchain as a valid block.

22. The operation method of claim 21, wherein the receiving, from an electronic device, of first transaction information comprises:
receiving, from the electronic device, the first transaction information of the first user transferring a predetermined amount of the cryptocurrency to the second user and a first cryptogram indicating a digital signature of the first transaction information.

23. The operation method of claim 22, wherein the verifying of the validity of the first transaction information based on the first transaction information and the information of the first event comprises:
generating a first hash value corresponding to the first transaction information by applying a hash function to the first transaction information;
generating a second hash value by decrypting the first cryptogram using a public key of the first user; and
verifying the validity of the first transaction information based on a result of comparing the first hash value with the second hash value and whether the information of the first event corresponds to the first transaction information.

24. The operation method of claim 21, comprising
verifying the validity of the first block by receiving a first block on which proof of work is completed from a second node on the network of the blockchain and confirming validity of at least one piece of transaction information included in the first block and validity of a block header of the first block;
if the first block is valid, adding the first block to a blockchain of the first node; and
if the first block is invalid, discarding the first block and generating a valid block to be added to the blockchain of the first node.
